(19) United States
(12) Patent Application Publication
(10) Pub. No.: US 2026/0025240 A1
(43) Pub. Date: Jan. 22, 2026

(54) RELIABLE NON-COHERENT TRANSMISSIONS

(71) Applicant: QUALCOMM Incorporated, San Diego, CA (US)

(72) Inventors: Yavuz YAPICI, Florham Park, NJ (US); Juergen CEZANNE, Ocean Township, NJ (US); Junyi LI, Greentown, PA (US)

(21) Appl. No.: 18/777,247

(22) Filed: Jul. 18, 2024

(51) Int. Cl. H04L 5/00; H04W 48/16; H04W 72/0453

(52) U.S. Cl. CPC H04L 5/0005; H04W 48/16; H04W 72/0453

(57) ABSTRACT

Methods, systems, and devices for wireless communications are described. A wireless device (e.g., a user equipment (UE)) may transmit a report message including one or more performance indicators, such as delay constraints and energy consumption, among other examples). Based thereon, another wireless device (e.g., a network entity) may transmit duty cycle information to the wireless device. The duty cycle information may include a duty cycle value (e.g., based on which a duty cycle duration can be determined or calculated), time and frequency resource indication of a transmission occasion, an index corresponding to previously configured candidate duty cycle value or transmission occasion, or the like. The wireless device may transmit non-coherent transmission (e.g., peaky transmissions) according to the duty cycle information.

### FIELD OF TECHNOLOGY

The following relates to wireless communications, including reliable non-coherent transmissions.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a wireless device is described. The method may include transmitting a report message including an indication of one or more performance parameters including at least one of an energy threshold for non-coherent transmission, and a delay constraint for non-coherent transmission, receiving, based on the one or more performance parameters, duty cycle information for non-coherent transmission, and transmitting a message via one or more transmission occasions according to a duty cycle that is based on the duty cycle information.

A wireless device for wireless communications is described. The wireless device may include one or more memories storing processor executable code, and one or more processors coupled with the one or more memories. The one or more processors may individually or collectively be operable to execute the code to cause the wireless device to transmit a report message including an indication of one or more performance parameters including at least one of an energy threshold for non-coherent transmission, and a delay constraint for non-coherent transmission, receive, based on the one or more performance parameters, duty cycle information for non-coherent transmission, and transmit a message via one or more transmission occasions according to a duty cycle that is based on the duty cycle information.

Another wireless device for wireless communications is described. The wireless device may include means for transmitting a report message including an indication of one or more performance parameters including at least one of an energy threshold for non-coherent transmission, and a delay constraint for non-coherent transmission, means for receiving, based on the one or more performance parameters, duty cycle information for non-coherent transmission, and means for transmitting a message via one or more transmission occasions according to a duty cycle that is based on the duty cycle information.

A non-transitory computer-readable medium storing code for wireless communications is described. The code may include instructions executable by one or more processors to transmit a report message including an indication of one or more performance parameters including at least one of an energy threshold for non-coherent transmission, and a delay constraint for non-coherent transmission, receive, based on the one or more performance parameters, duty cycle information for non-coherent transmission, and transmit a message via one or more transmission occasions according to a duty cycle that is based on the duty cycle information.

In some examples of the method, wireless devices, and non-transitory computer-readable medium described herein, transmitting the message may include operations, features, means, or instructions for transmitting a first portion of the message via a first transmission occasion of the one or more transmission occasions, the first transmission occasion including a first set of time resources and a first set of frequency resources and transmitting a second portion of the message via a second transmission occasion of the one or more transmission occasions, the second transmission occasion including a second set of time resources and a second set of frequency resources, where the second set of time resources may be offset from the first set of time resources by a time duration according to the duty cycle.

In some examples of the method, wireless devices, and non-transitory computer-readable medium described herein, the duty cycle information includes a duty cycle value and a peak transmission power for transmitting the message may be equal to an average transmission power divided by the duty cycle value.

In some examples of the method, wireless devices, and non-transitory computer-readable medium described herein, the duty cycle information includes a duty cycle value that corresponds to a first transmission occasion of the one or more transmission occasions occurring within the duty cycle, and a second transmission occasion of the one or more transmission occasions occurring with the duty cycle, the second transmission occasion occurring in a last available transmission occasion prior to expiration of the delay constraint.

In some examples of the method, wireless devices, and non-transitory computer-readable medium described herein, the duty cycle information includes an indication of a last transmission occasion of the one or more transmission occasions occurring within the duty cycle.

Some examples of the method, wireless devices, and non-transitory computer-readable medium described herein may further include operations, features, means, or instructions for receiving control signaling indicating a set of multiple candidate transmission occasions, where the duty cycle information includes an indication of the last transmission occasion from the set of multiple candidate transmission occasions.

Some examples of the method, wireless devices, and non-transitory computer-readable medium described herein may further include operations, features, means, or instructions for receiving control signaling indicating a lookup table including a set of multiple index values and a set of multiple candidate duty cycle values, each index value of the set of multiple index values corresponding to a respective candidate duty cycle value of the set of multiple candidate duty cycle values, where the duty cycle information includes an index value of the set of multiple index values indicating a first duty cycle value corresponding to the duty cycle.

Some examples of the method, wireless devices, and non-transitory computer-readable medium described herein may further include operations, features, means, or instructions for receiving control signaling indicating whether the wireless device may be to transmit one or more repetitions of the message during the duty cycle, where transmitting the message may be based on receiving the control signaling.

In some examples of the method, wireless devices, and non-transitory computer-readable medium described herein, transmitting the message may include operations, features, means, or instructions for transmitting the message via a first set of transmission occasions and transmitting a repetition of the message via a second set of transmission occasions, where the first set of transmission occasions and the second set of transmission occasions occur within the duty cycle according to the duty cycle information.

In some examples of the method, wireless devices, and non-transitory computer-readable medium described herein, the first set of transmission occasions and the second set of transmission occasions of the duty cycle satisfy the delay constraint.

Some examples of the method, wireless devices, and non-transitory computer-readable medium described herein may further include operations, features, means, or instructions for transmitting the message includes transmitting one or more non-coherent peaky transmissions.

A method for wireless communications by a wireless device is described. The method may include receiving a report message including an indication of one or more performance parameters including at least one of an energy threshold for non-coherent transmission by a second wireless device, and a delay constraint for non-coherent transmission by the second wireless device, transmitting, based on the one or more performance parameters, duty cycle information for non-coherent transmissions, and receiving a message via one or more transmission occasions according to a duty cycle that is based on the duty cycle information.

A wireless device for wireless communications is described. The wireless device may include one or more memories storing processor executable code, and one or more processors coupled with the one or more memories. The one or more processors may individually or collectively be operable to execute the code to cause the wireless device to receive a report message including an indication of one or more performance parameters including at least one of an energy threshold for non-coherent transmission by a second wireless device, and a delay constraint for non-coherent transmission by the second wireless device, transmit, based on the one or more performance parameters, duty cycle information for non-coherent transmissions, and receive a message via one or more transmission occasions according to a duty cycle that is based on the duty cycle information.

Another wireless device for wireless communications is described. The wireless device may include means for receiving a report message including an indication of one or more performance parameters including at least one of an energy threshold for non-coherent transmission by a second wireless device, and a delay constraint for non-coherent transmission by the second wireless device, means for transmitting, based on the one or more performance parameters, duty cycle information for non-coherent transmissions, and means for receiving a message via one or more transmission occasions according to a duty cycle that is based on the duty cycle information.

A non-transitory computer-readable medium storing code for wireless communications is described. The code may include instructions executable by one or more processors to receive a report message including an indication of one or more performance parameters including at least one of an energy threshold for non-coherent transmission by a second wireless device, and a delay constraint for non-coherent transmission by the second wireless device, transmit, based on the one or more performance parameters, duty cycle information for non-coherent transmissions, and receive a message via one or more transmission occasions according to a duty cycle that is based on the duty cycle information.

In some examples of the method, wireless devices, and non-transitory computer-readable medium described herein, receiving the message may include operations, features, means, or instructions for receiving a first portion of the message via a first transmission occasion of the one or more transmission occasions, the first transmission occasion including a first set of time resources and a first set of frequency resources and receiving a second portion of the message via a second transmission occasion of the one or more transmission occasions, the second transmission occasion including a second set of time resources and a second set of frequency resources, where the second set of time resources may be offset from the first set of time resources by a time duration according to the duty cycle.

In some examples of the method, wireless devices, and non-transitory computer-readable medium described herein, the duty cycle information includes a duty cycle value that corresponds to a first transmission occasion of the one or more transmission occasions occurring within the duty cycle, and a second transmission occasion of the one or more transmission occasions occurring with the duty cycle, the second transmission occasion occurring in a last available transmission occasion prior to expiration of a time duration indicated by the delay constraint.

Some examples of the method, wireless devices, and non-transitory computer-readable medium described herein may further include operations, features, means, or instructions for selecting the duty cycle value from a set of multiple candidate duty cycle values based on the delay constraint, where the selected duty cycle value corresponds to the duty cycle having a duration that satisfies the delay constraint.

In some examples of the method, wireless devices, and non-transitory computer-readable medium described herein, the duty cycle information includes an indication of a last transmission occasion of the one or more transmission occasions occurring within the duty cycle.

Some examples of the method, wireless devices, and non-transitory computer-readable medium described herein may further include operations, features, means, or instructions for transmitting control signaling indicating a set of multiple candidate transmission occasions, where the duty cycle information includes an indication of the last transmission occasion from the set of multiple candidate transmission occasions.

Some examples of the method, wireless devices, and non-transitory computer-readable medium described herein may further include operations, features, means, or instructions for selecting the last transmission occasion from a set of multiple candidate transmission indications based on the last transmission occasion occurring prior to expiration of the delay constraint.

Some examples of the method, wireless devices, and non-transitory computer-readable medium described herein may further include operations, features, means, or instructions for transmitting control signaling indicating a lookup table including a set of multiple index values and a set of multiple candidate duty cycle values, each index value of the set of multiple index values corresponding to a respective candidate duty cycle value of the set of multiple candidate duty cycle values, where the duty cycle information includes an index value of the set of multiple index values indicating a first duty cycle value corresponding to the duty cycle.

Some examples of the method, wireless devices, and non-transitory computer-readable medium described herein may further include operations, features, means, or instructions for transmitting control signaling indicating whether the wireless device may be to transmit one or more repetitions of the message during the duty cycle, where receiving the message may be based on receiving the control signaling.

Some examples of the method, wireless devices, and non-transitory computer-readable medium described herein may further include operations, features, means, or instructions for determining, based on the one or more performance parameters, whether the wireless device may be to transmit one or more repetitions of the message during the duty cycle, where transmitting the control signaling may be based on the determining.

Some examples of the method, wireless devices, and non-transitory computer-readable medium described herein may further include operations, features, means, or instructions for receiving the message via a first set of transmission occasions and receiving a repetition of the message via a second set of transmission occasions, where the first set of transmission occasions and the second set of transmission occasions occur within the duty cycle according to the duty cycle information.

In some examples of the method, wireless devices, and non-transitory computer-readable medium described herein, the first set of transmission occasions and the second set of transmission occasions of the duty cycle satisfy the delay constraint.

Some examples of the method, wireless devices, and non-transitory computer-readable medium described herein may further include operations, features, means, or instructions for transmitting the message includes transmitting one or more non-coherent peaky transmissions.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports reliable non-coherent transmissions in accordance with one or more aspects of the present disclosure.

FIG. 2 shows an example of a timeline that supports reliable non-coherent transmissions in accordance with one or more aspects of the present disclosure.

FIG. 3 shows an example of a timeline that supports reliable non-coherent transmissions in accordance with one or more aspects of the present disclosure.

FIG. 4 shows an example of a timeline that supports reliable non-coherent transmissions in accordance with one or more aspects of the present disclosure.

FIG. 5 shows an example of a timeline that supports reliable non-coherent transmissions in accordance with one or more aspects of the present disclosure.

FIG. 6 shows an example of a timeline that supports reliable non-coherent transmissions in accordance with one or more aspects of the present disclosure.

FIGS. 7 and 8 show block diagrams of devices that support reliable non-coherent transmissions in accordance with one or more aspects of the present disclosure.

FIG. 9 shows a block diagram of a communications manager that supports reliable non-coherent transmissions in accordance with one or more aspects of the present disclosure.

FIG. 10 shows a diagram of a system including a device that supports reliable non-coherent transmissions in accordance with one or more aspects of the present disclosure.

FIGS. 11 and 12 show block diagrams of devices that support reliable non-coherent transmissions in accordance with one or more aspects of the present disclosure.

FIG. 13 shows a block diagram of a communications manager that supports reliable non-coherent transmissions in accordance with one or more aspects of the present disclosure.

FIG. 14 shows a diagram of a system including a device that supports reliable non-coherent transmissions in accordance with one or more aspects of the present disclosure.

FIGS. 15 through 18 show flowcharts illustrating methods that support reliable non-coherent transmissions in accordance with one or more aspects of the present disclosure.

### DETAILED DESCRIPTION

Some wireless communications systems may experience poor signal to noise ratio (SNR) conditions, and may utilize non-coherent transmissions (e.g., peaky transmissions) which do not rely on demodulation reference signals (DMRSs) and channel state information (CSI) information. Transmission power for non-coherent transmissions may be concentrated over specific time and frequency resources, and such non-coherent transmissions are to be transmitted according to a duty cycle, as a compensation for increased peak transmit power over the occupied time-frequency grid. However, if the duty cycle is selected to be too long (e.g., to be able to further increase peak transmit power), the wireless communications system may experience decreased rates (e.g., as a same quantity of data bits are transmitted over a longer time period), increased latency and delays, and decreased throughput. Alternatively, if the duty cycle is too short, then the transmit power for the non-coherent transmissions may be constrained such that non-coherent transmissions are transmitted at decreased reliability (e.g., an increased block error rate (BLER)). Some wireless communications systems may not support mechanisms to determine an appropriate duty cycle duration to achieve a balance between rates and reliability. Without such a mechanism, non-coherent transmission may fail (e.g., due to poor reliability), resulting in increased need for retransmission (if possible based on system configuration), system congestion, inefficient use of available system resources, increased delays, and poor user experience, or resulting in increased delays (e.g., due to a long duty cycle and poor rates), increased system latency, and poor user experience.

Techniques described herein support mechanisms for selecting or determining duty cycle duration to improve both rate and reliability of non-coherent transmissions. A wireless device (e.g., a user equipment (UE)) may transmit a report message including one or more performance indicators, such as delay constraints and energy consumption, among other examples). Based thereon, another wireless device (e.g., a network entity) may transmit duty cycle information to the wireless device. The duty cycle information may include a duty cycle value (e.g., based on which a duty cycle duration can be determined or calculated), time and frequency resource indication of a transmission occasion, an index corresponding to previously configured candidate duty cycle value or transmission occasion, or the like. The wireless device may transmit non-coherent transmission (e.g., peaky transmissions) according to the duty cycle information.

Aspects of the disclosure are initially described in the context of wireless communications systems. Aspects of the disclosure are further illustrated by and described with reference to timelines and process flows. Aspects of the disclosure are further illustrated by and described with reference to apparatus diagrams, system diagrams, and flowcharts that relate to reliable non-coherent transmissions.

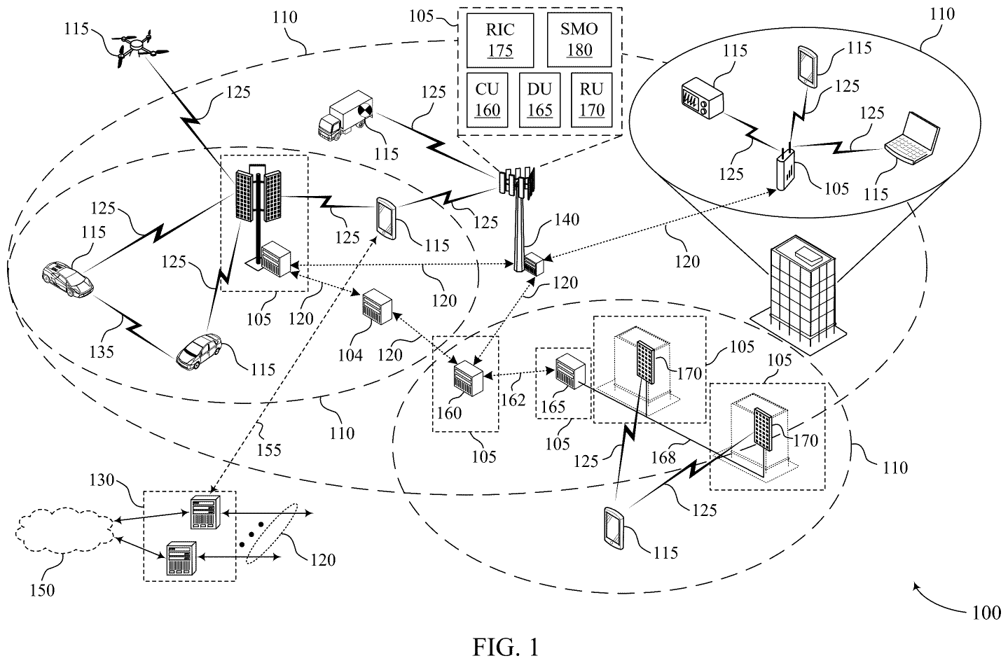

FIG. 1 shows an example of a wireless communications system 100 that supports reliable non-coherent transmissions in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

For instance, an access network (AN) or RAN may include communications between access nodes (e.g., an IAB donor), IAB node(s) 104, and one or more UEs 115. The IAB donor may facilitate connection between the core network 130 and the AN (e.g., via a wired or wireless connection to the core network 130). That is, an IAB donor may refer to a RAN node with a wired or wireless connection to the core network 130. The IAB donor may include one or more of a CU 160, a DU 165, and an RU 170, in which case the CU 160 may communicate with the core network 130 via an interface (e.g., a backhaul link). The IAB donor and IAB node(s) 104 may communicate via an F1 interface according to a protocol that defines signaling messages (e.g., an F1 AP protocol). Additionally, or alternatively, the CU 160 may communicate with the core network 130 via an interface, which may be an example of a portion of a backhaul link, and may communicate with other CUs (e.g., including a CU 160 associated with an alternative IAB donor) via an Xn-C interface, which may be an example of another portion of a backhaul link.

IAB node(s) 104 may refer to RAN nodes that provide IAB functionality (e.g., access for UEs 115, wireless self-backhauling capabilities). A DU 165 may act as a distributed scheduling node towards child nodes associated with the IAB node(s) 104, and the IAB-MT may act as a scheduled node towards parent nodes associated with IAB node(s) 104. That is, an IAB donor may be referred to as a parent node in communication with one or more child nodes (e.g., an IAB donor may relay transmissions for UEs through other IAB node(s) 104). Additionally, or alternatively, IAB node(s) 104 may also be referred to as parent nodes or child nodes to other IAB node(s) 104, depending on the relay chain or configuration of the AN. The IAB-MT entity of IAB node(s) 104 may provide a Uu interface for a child IAB node (e.g., the IAB node(s) 104) to receive signaling from a parent IAB node (e.g., the IAB node(s) 104), and a DU interface (e.g., a DU 165) may provide a Uu interface for a parent IAB node to signal to a child IAB node or UE 115.

For example, IAB node(s) 104 may be referred to as parent nodes that support communications for child IAB nodes, or may be referred to as child IAB nodes associated with IAB donors, or both. An IAB donor may include a CU 160 with a wired or wireless connection (e.g., backhaul communication link(s) 120) to the core network 130 and may act as a parent node to IAB node(s) 104. For example, the DU 165 of an IAB donor may relay transmissions to UEs 115 through IAB node(s) 104, or may directly signal transmissions to a UE 115, or both. The CU 160 of the IAB donor may signal communication link establishment via an F1 interface to IAB node(s) 104, and the IAB node(s) 104 may schedule transmissions (e.g., transmissions to the UEs 115 relayed from the IAB donor) through one or more DUs (e.g., DUs 165). That is, data may be relayed to and from IAB node(s) 104 via signaling via an NR Uu interface to MT of IAB node(s) 104 (e.g., other IAB node(s)). Communications with IAB node(s) 104 may be scheduled by a DU 165 of the IAB donor or of IAB node(s) 104.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a multimedia/entertainment device (e.g., a radio, a MP3 player, or a video device), a camera, a gaming device, a navigation/positioning device (e.g., GNSS (global navigation satellite system) devices based on, for example, GPS (global positioning system), Beidou, GLONASS, or Galileo, or a terrestrial-based device), a tablet computer, a laptop computer, a netbook, a smartbook, a personal computer, a smart device, a wearable device (e.g., a smart watch, smart clothing, smart glasses, virtual reality goggles, a smart wristband, smart jewelry (e.g., a smart ring, a smart bracelet)), a drone, a robot/robotic device, a vehicle, a vehicular device, a meter (e.g., parking meter, electric meter, gas meter, water meter), a monitor, a gas pump, an appliance (e.g., kitchen appliance, washing machine, dryer), a location tag, a medical/healthcare device, an implant, a sensor/actuator, a display, or any other suitable device configured to communicate via a wireless or wired medium, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ−N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may support synchronous or asynchronous operation. For synchronous operation, network entities 105 (e.g., base stations 140) may have similar frame timings, and transmissions from different network entities (e.g., different ones of the network entities 105) may be approximately aligned in time. For asynchronous operation, network entities 105 may have different frame timings, and transmissions from different network entities (e.g., different ones of network entities 105) may, in some examples, not be aligned in time. The techniques described herein may be used for either synchronous or asynchronous operations.

Some UEs 115, such as MTC or IoT devices, may be relatively low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging. In an aspect, techniques disclosed herein may be applicable to MTC or IoT UEs. MTC or IoT UEs may include MTC/enhanced MTC (eMTC, also referred to as CAT-M, Cat M1) UEs, NB-IoT (also referred to as CAT NB1) UEs, as well as other types of UEs. eMTC and NB-IoT may refer to future technologies that may evolve from or may be based on these technologies. For example, eMTC may include FeMTC (further eMTC), eFeMTC (enhanced further eMTC), and mMTC (massive MTC), and NB-IoT may include eNB-IoT (enhanced NB-IoT), and FeNB-IoT (further enhanced NB-IoT).

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 may include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by a transmitting device (e.g., a network entity 105 or a UE 115) along a single beam direction (e.g., a direction associated with the receiving device, such as another network entity 105 or UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest SNR, or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

Techniques described herein support mechanisms for selecting or determining duty cycle duration to improve both rate and reliability of non-coherent transmissions. A wireless device (e.g., a user equipment (UE 115)) may transmit a report message including one or more performance indicators, such as delay constraints and energy consumption, among other examples). Based thereon, another wireless device (e.g., a network entity 105) may transmit duty cycle information to the wireless device. The duty cycle information may include a duty cycle value (e.g., based on which a duty cycle duration can be determined or calculated), time and frequency resource indication of a transmission occasion, an index corresponding to previously configured candidate duty cycle value or transmission occasion, or the like. The wireless device may transmit non-coherent transmission (e.g., peaky transmissions) according to the duty cycle information.

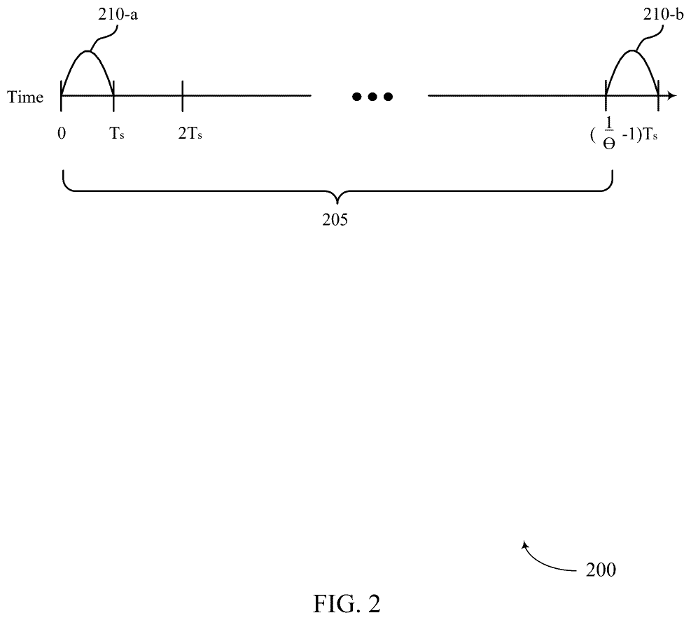

FIG. 2 shows an example of a timeline 200 that supports reliable non-coherent transmissions in accordance with one or more aspects of the present disclosure. The timeline 200 may implement, or be implemented by, aspects of the wireless communications system 100. For example, a one or more device (e.g., a UE 115, or a network entity 105, which may be examples of corresponding devices described with reference to FIG. 1) may communicate according to the timeline 200.

In some examples, a wireless device (e.g., a UE 115) may communicate in a low SNR scenario. For example, wireless communication may be impacted by high pathloss, or wideband deployments, where received energy per spectrum unit (e.g., Hz) may be low under a fixed transmit power. Reliable channel state information (CSI) at a receiving device may be a problem in such low SNR scenarios. In such examples, obtaining CSI reliably (e.g., to a precision sufficient for coherent detection) may be infeasible (e.g., under low SNR conditions). In such examples, the wireless communications system may support non-coherent transmissions (e.g., which may be referred to as peaky transmissions) without relying on any CSI acquisition by the receiving device (e.g., without any pilot transmissions). That is, if a received power is not sufficient to obtain the CSI reliably at the receiver device for a given bandwidth (e.g., in low SNR conditions over a given bandwidth), the wireless communications system may rely on non-coherent transmissions, which do not rely on tracking carrier phase (e.g., the receiver device does not perform CSI estimation), and therefore does not rely on demodulation reference signals (DMRSs), resulting in improved frequency resource utilization.

Non-coherent transmissions may include peaky transmissions (e.g., peaky transmissions 210). Peaky transmissions may rely on scheduling peaky OFDM symbols within a duty cycle (e.g., a duty cycle 205, which may represent a time duration between initiation of consecutive peaky transmissions). The duty cycle 205 may boost peak transmit power relied upon for receiver detection of energy-bearing tones under low SNR conditions. Thus, peaky transmissions 210 only occur during a fraction of available time resources, and the peak transmit power of the peaky transmissions 210 is increased (e.g., in proportion to the inverse of the duty cycle). Thus, peaky transmission transmit power is concentrated over time resources and frequency resources (e.g., via selecting a few frequency tones for each peaky transmission, and transmitting only via time resources according to the duty cycle 205).

For example, a wireless device (e.g., the UE 115) may transmit a first peaky transmission 210-a (e.g., a first pulse) via a first set of frequency resources and a first set of time resources and a second peaky transmission 210-b (e.g., a second pulse) via a second set of frequency resources and a second set of time resources. The first set of frequency resources may be defined by a center frequency plus a frequency offset (e.g., f_{c}+mΔf), and the second set of frequency resources may be defined by the center frequency plus a second frequency offset (e.g., f_{c}+nΔf). The first set of time resources and the second set of time resources may be defined according to the duty cycle 205. Each pulse may be transmitted with a duty cycle 205, with a duty cycle value θ, such that θ<1, and a peak power of P_{avg}/θ where P_{avg} is the average transmit power. The duty cycle 205 may be defined according to the duty cycle value θ, such that

$${P}_{peak} = \frac{{P}_{avg}}{θ} >> {P}_{avg} .$$

Thus, the duration of the duty cycle 205 may be inversely proportional to the duty cycle value of θ. That is, the first peaky transmission 210-a may be transmitted via time resources spanning from time 0 to time Tₛ (e.g., the duration of the first pulse). The second peaky transmission 210-b may be initiated at time

$$( \frac{1}{θ} - 1 ) {T}_{s} .$$

Thus, the smaller the value of θ, the larger the duration of the duty cycle 205. In some examples, the duty cycle 205 may be referred to as a duty cycle of θ, a θ duty cycle, or a duty cycle θ. Thus, a small duty cycle θ may refer to a large value of θ, and a large duty cycle θ may refer to a large duty cycle duration based on a small value of θ.

Improver selection of a duty cycle 205, however, may lead to unreliable data rates for peaky transmissions. That is, if the duty cycle 205 is too long, data rates may significantly decrease. However, if the duty cycle is too small, the peaky transmissions may be less reliable (e.g., may not be successfully received, resulting in retransmission or more repetitions, system congestion, increased system delay, etc.). Techniques described herein support duty cycle duration selection and transmission timing to manage a tradeoff between data rate and transmission reliability under different delay constraints (e.g., transmission timing may be different for stringent delay constraints than for more relaxed data constraints, and reliability and throughput may be improved based on the current constraints). Techniques described herein therefore support efficient scheduling of peaky transmissions 210 (e.g., peaky OFDM symbols) according to a set of current key performance indicators to achieve a best available data rate and reliability.

Techniques described herein support mechanisms for selecting or determining duty cycle duration to improve both rate and reliability of non-coherent transmissions. A wireless device (e.g., a UE) may transmit a report message including one or more performance indicators, such as delay constraints and energy consumption, among other examples). Based thereon, another wireless device (e.g., a network entity) may transmit duty cycle information to the wireless device. The duty cycle information may include a duty cycle value (e.g., based on which a duty cycle duration can be determined or calculated), time and frequency resource indication of a transmission occasion, an index corresponding to previously configured candidate duty cycle value or transmission occasion, or the like. The wireless device may transmit non-coherent transmission (e.g., peaky transmissions) according to the duty cycle information.

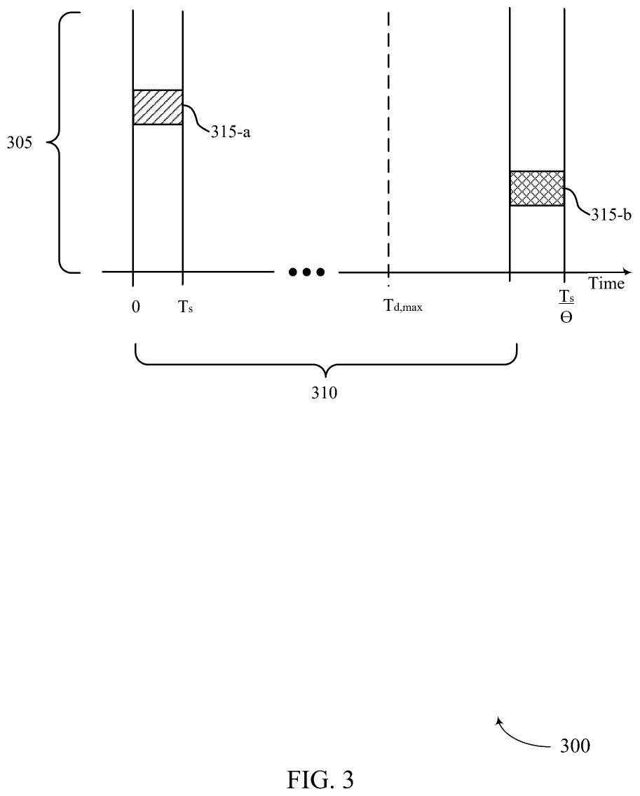

FIG. 3 shows an example of a timeline 300 that supports reliable non-coherent transmissions in accordance with one or more aspects of the present disclosure. The timeline 300 may implement, or be implemented by, aspects of the wireless communications system 100 and the timeline 200. For example, a one or more device (e.g., a UE 115, or a network entity 105, which may be examples of corresponding devices described with reference to FIGS. 1-2) may communicate according to the timeline 300.

In non-coherent transmissions using peaky waveforms, the capacity of the underlying channel can be improved through adjusting the duty cycle period, which is represented by a factor (e.g., the duty cycle value θ), such that θ≤1. A sufficiently small value of θ may be utilized to boost the data rate through increasing peak transmit power while keeping the average transmit power the same (e.g., to achieve a close to capacity additive white Gaussian noise (AWGN) capacity). However, such a small value of θ may be practically useless if an available bandwidth (e.g., bandwidth 305) is not large enough (e.g., harmful impacts to wireless communications due to the transmission period being longer may still be more consequential than a corresponding achievable benefit due to the boosted peak power). In practical circumstances, frequency resources may be limited and allocated bandwidths (e.g., the bandwidth 305) may not be arbitrarily large (e.g., much below a level dictated by some duty cycle values of θ).

Techniques described herein support selection of a duty cycle value θ that is not small enough to boost data rates such that a probability of error (e.g., a block error rate (BLER)) is not small enough although rates are higher. That is, a wireless communications system may support wireless communications that are expected to satisfy quality of server (QoS) requirements (e.g., a threshold (e.g., maximum) delay, a retransmission capability, etc.). Selections of duty cycles 310 may impact reliability, rate, throughput, and energy consumption. For instance, a longer duty cycle 310 may result in increased reliability due to a higher transmit power concentrated at each peaky transmission 315. However, the longer duty cycle 310 may also result in decreased rates and throughput, and in some examples may exceed a threshold transmission delay time (e.g., which may be referred to as T_{d,max}). A shorter duty cycle 310 may increase the rate and throughput, but may negatively impact reliability (e.g., may increase a BLER due to the decreased transmit power in low SNR conditions). Thus, selection of a duration of the duty cycle 310 may take into account the tradeoff between higher rates (e.g., without transmission) and reliable rates, with consideration of an impact on the QoS requirements.

According to techniques described herein, a network entity 105 may configure a UE 115, which is capable of communicating non-coherently, via peaky waveforms (e.g., the peaky transmissions 315). The network entity 105 may configure the peaky transmissions 315 according to a duty cycle value θ considering respective performance KPIs (e.g., energy consumption, budget, delay constraints, etc.). Such scheduling may benefit from a balance between data rate and transmission reliability.

For example, transmissions (e.g., the peaky transmissions 315) may be subject to a delay requirement or constraint (e.g., T_{d,max}). In such examples, a packet may be transmitted via multiple peaky transmissions 315 (e.g., a first portion of a packet, such as a data packet, transmitted via a first peaky transmission 315-a and a second portion of the packet transmitted via the second peaky transmission 315-b). In such examples, if the duty cycle value θ is too small, the second peaky transmission 315-b may occur after T_{d,max} from the initial peaky transmission 315-a (e.g., which may not be acceptable under the delay constraint for the transmission). That is, if the duty cycle value θ is too small, then the full packet may not be transmitted prior to expiration of the delay constraint T_{d,max}. On the other hand, if the duty cycle value θ is too large (e.g., larger than what is necessary to achieve transmission of the complete packet prior to T_{d,max}), then reliability may be negatively impacted (e.g., resulting in failed reception, retransmissions, inefficient use of system resources, etc.). For instance, if a first value of the duty cycle is low (e.g., θ=0.01), the peaky transmissions 315 may be received with an acceptable BLER (e.g., about 0.14). However, if a second value of the duty cycle is set higher (e.g., θ=0.1), then the peaky transmissions 315 may be impacted by another BLER (e.g., about 0.74), which may not be acceptable (e.g., may result in failed reception, retransmission, etc.).

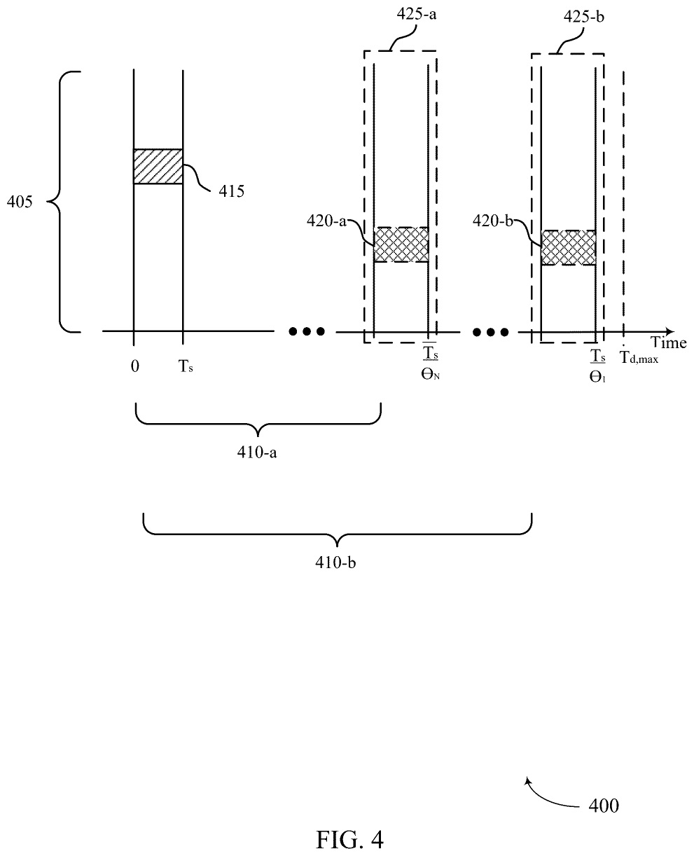

As described in greater detail with reference to FIG. 4, under stringent delay constraints, the network entity may configure the peaky transmissions 315 according to a smallest duty cycle value θ for which a last peaky symbol (e.g., the last peaky transmission 315-b among a set of all peaky symbols forming a packet) is transmitted prior to T_{d,max}. In some cases, the selection may then be adjusted (e.g., or initially set) according to largest duty cycle values θ that might result in higher rates at the expense of decreased (e.g., but still acceptable) levels of reliability.

FIG. 4 shows an example of a timeline 400 that supports reliable non-coherent transmissions in accordance with one or more aspects of the present disclosure. The timeline 400 may implement, or be implemented by, aspects of the wireless communications system 100, the timeline 200, and the timeline 300. For example, a one or more device (e.g., a UE 115, or a network entity 105, which may be examples of corresponding devices described with reference to FIGS. 1-3) may communicate according to the timeline 400 and via frequency resources of the bandwidth 405.

In some examples, one or more transmissions may be subject to stringent delay constraints. For example, a UE may report one or more KPIs, which may include a delay constraint (e.g., T_{d,max}, indicating a time duration during which all peaky transmission corresponding to a packet are to be received by the receiving device). The network entity may configure the peaky transmissions according to a smallest duty cycle value θ for which a last peaky symbol (e.g., the last peaky transmission 420 among a set of all peaky symbols forming a packet) is transmitted prior to T_{d,max}. Such a transmission may result in high liability, but low data rates. In some cases, the selection may then be adjusted (e.g., or initially set) according to largest duty cycle values θ that might result in higher rates at the expense of decreased (e.g., but still acceptable) levels of reliability.

For example, a packet may be carried by multiple peaky transmissions The set of peaky transmissions may include any number of peaky transmissions (e.g., a first peaky transmission 415 and at least a last peaky transmissions 420, with any number of additional peaky transmissions occurring between the peaky transmission 415 and the last peaky transmission 420).

A duty cycle 410-a or a duty cycle 410-b may be used in scheduling the peaky transmissions. Time resources via which the duty cycle is transmitted may be selected and configured based on reported KPIs from the UE. For instance, the first peaky transmission 415 may be scheduled during time resources (e.g., one or more symbols) spanning from θ to Tₛ. Another (e.g., last) peaky transmission may be scheduled prior to T_{d,max}, in a transmission occasion 425. Each transmission occasion 425 (e.g., transmission occasion 425-a or transmission occasion 425-b) may span one or more OFDM symbols. Transmission of the peaky transmission 420-a during the transmission occasion 425-a may result in a higher data rate (e.g., because it occurs earlier in time) but decreased reliability (e.g., because the duty cycle 410-a is shorter than the duty cycle 410-b). Transmission of the peaky transmission 420-b via the transmission occasion 425-b may result in a lower data rate (e.g., because the transmission occasion 425-b occurs later in time than the transmission occasion 425-a), but an increased reliability (e.g., because the duty cycle 410-b is longer than the duty cycle 410-a).

In configuring the duty cycle 410 (e.g., or the duty cycle value θ) for the peaky transmissions, the network entity may determine a smallest duty cycle value θ for which a last peaky symbol (e.g., the peaky transmission 420) is transmitted just before T_{d,max} (e.g., the transmission occasion 425-b). The network may also adjust the duty cycle (e.g., the duty cycle value θ), or may initially set the duty cycle, to achieve a higher data rate (e.g., an earlier transmission occasion 425) at the expense of decreasing the reliability (e.g., to a decreased but still acceptable reliability). For example, the network entity may determine that transmission of the peaky transmission 420-a via the transmission occasion 425-a may result in increased rate without decreasing the reliability (e.g., such that a reliability threshold is satisfied, such as a threshold BLER). In some examples, the network may initially select an earlier transmission occasion 425-a that satisfies a reliability threshold. In some examples, the network entity may initially select the smallest duty cycle value θ that satisfies T_{d,max}, and then may adjust (e.g., increase) the duty cycle value θ up to or based on a threshold reliability (e.g., a threshold BLER associated with an earlier transmission occasion 425-a), and may then select the earlier transmission occasion 425-a based on the adjusting. In some examples, no earlier transmission occasion 425 may satisfy a threshold reliability, in which case the network entity may select and configure the transmission occasion 425-b.

The network may indicate duty cycle information for non-coherent transmission (e.g., may configure the peaky transmissions). For example, the network entity may indicate to the UE a duration of the duty cycle (e.g., an indication of the duty cycle 410-a, or 410-b), or an indication of a duty cycle value θ corresponding to an indicated transmission occasion 425, or an indication of one or more transmission occasions 425, among other examples. The UE may then send the peaky transmission according to the configured duty cycle information.

In some examples, the network may select one or more alternative transmission occasions 425 (e.g., or duty cycle values θ corresponding to the selected transmission occasions 425). The network may then indicate the selected transmission occasions to the UE. For example, the network entity may indicate, to the UE, one or more transmission occasions 425 of a set of predefined transmission occasions. The predefined transmission occasions may be configured or preconfigured at the UE, or may be defined in one or more standards documents. The set of candidate transmission occasions may include an indication the transmission occasions 425-a and the transmission occasion 425-b. In some examples, the duty cycle information may include an indication of (e.g., an index to) the selected transmission occasions (e.g., an indication of the transmission occasion 425-a, in which case the UE may transmit the peaky transmission 420-a via the transmission occasion 425-a). Such an indication may result in reduced signaling overhead (e.g., as the duty cycle information includes an index to configured or preconfigured information).

In some examples, the duty cycle information may include an indication of the transmission occasion (e.g., without reference to any preconfigured or configured information). Such an indication may be specific and therefore more energy efficient for the UE.

In some examples, the duty cycle information may include an indication of a duty cycle value θ. The network entity may select a duty cycle value from a set of candidate duty cycle values θ (e.g., from a predefined lookup table, which may be configured or preconfigured at the UE) and indicate the selected duty cycle to the UE. The duty cycle values θ may be selected based on the tradeoff between data rate and tolerance to reliability. In such examples, the duty cycle information may include an indication of the selected duty cycle values θ (e.g., an index to the lookup table, which may indicate θ_{N} for the transmission occasion 425-a, or θ₁ for the transmission occasion 425-b). The UE may then transmit the peaky transmission according to the configured duty cycle.

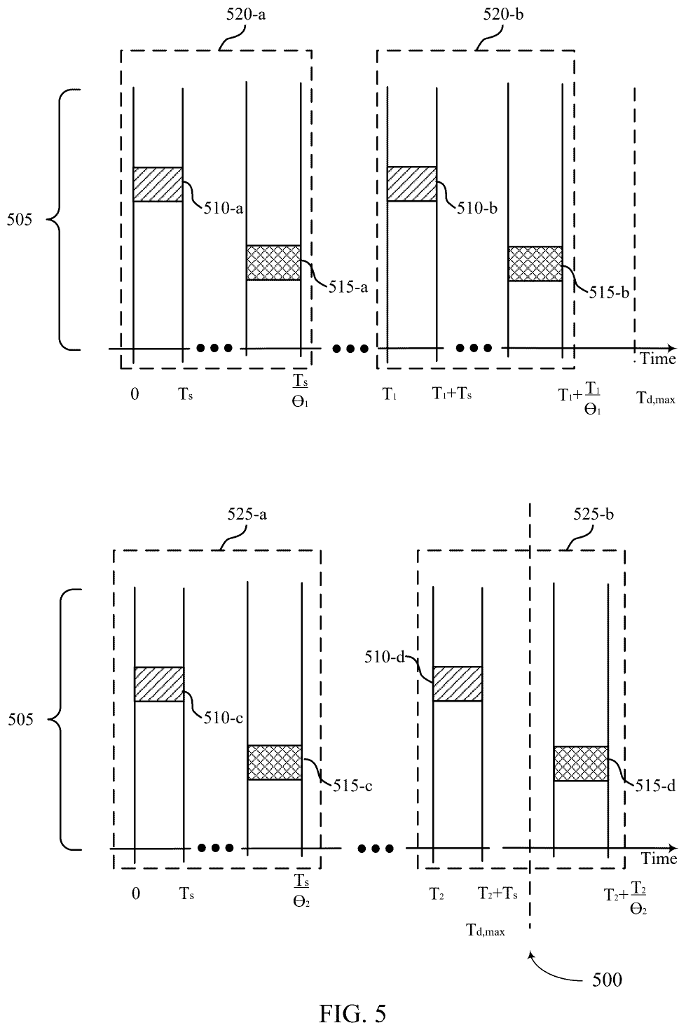

In some examples, as described in greater detail with reference to FIG. 5, the duty cycle information (e.g., the duty cycle θ) may be selected in cases with less stringent delay constraints. In some examples, the UE may report KPIs, which may include a delay constraint. If the delay constraint satisfies a threshold, then the network entity may select the duty cycle value θ (e.g., or otherwise configure the peaky transmissions) according to a first set of rules (e.g., a duty cycle value θ selected to satisfy the delay constraint, and adjusted or set according to an acceptable reliability level, as described with reference to FIG. 4). In some examples, the network entity may select the duty cycle value θ (e.g., or otherwise configure the peaky transmissions) according to a second set of rules if the delay constraint fails to satisfy the threshold, or satisfies a second threshold (e.g., may determine whether and when to transmit repetitions of the packet as described in greater detail with reference to FIG. 5). In some examples, a determination of which rules to utilize may be based on an impact on reliability or rate predicted based on a duty cycle value θ that satisfies the delay constraint.

FIG. 5 shows an example of a timeline 500 that supports reliable non-coherent transmissions in accordance with one or more aspects of the present disclosure. The timeline 500 may implement, or be implemented by, aspects of the wireless communications system 100, the timeline 200, the timeline 300, and the timeline 400. For example, a one or more device (e.g., a UE 115, or a network entity 105, which may be examples of corresponding devices described with reference to FIGS. 1-4) may communicate according to the timeline 500 and via the frequency resources of a bandwidth 505.

In some examples, peaky transmissions may be subject to less stringent (e.g., more relaxed or loose) delay constraints. For example, under a delay constraint T_{d,max}, which may be reported by the UE, the network may determine that a relatively small duty cycle value θ may result in a reliable transmission (e.g., a relatively large transmit power that may satisfy a threshold according to a peaky transmission configuration). However, such a small duty cycle value θ (e.g., the smallest duty cycle value θ that satisfies T_{d,max}) may result in increased reliability and decreased rates. A larger duty cycle value θ may still satisfy T_{d,max} with increased higher data rates (e.g., and decreased reliability). In some examples, the network entity may select a duty cycle value θ (e.g., or one or more transmission occasion), even with more relaxed delay constraints, as described with reference to FIG. 4 (e.g., according to a first set of rules and conditions and the reported KPIs). For instance, the network entity may not consider repetitions within the delay constraint. However, in some examples, as described with reference to FIG. 5, the network entity may consider a retransmission strategy (e.g., or some kind of feedback mechanism such as a HARQ mechanism) when a delay constraint is sufficiently large (e.g., satisfies a threshold or one or more conditions). In some examples, if a retransmission configuration results in violation of the delay constraint, the network entity may default to techniques described with reference to FIG. 4 (e.g., may refrain from scheduling repetitions of peaky transmissions).

In some examples, the network entity may improve reliability of the peaky transmissions via retransmission (e.g., one or more repetitions). That is, a small duty cycle and non-stringent delay requirements may leave sufficient time for a retransmission prior to expiration of the delay constraint T_{d,max}. In such examples, the UE may transmit a first repetition 520-a (e.g., an initial transmission) of a packet via peaky transmissions (e.g., a first portion of the packet via the peaky transmission 510-a, and a second portion of the packet via the peaky transmission 515-a). The first peaky transmission 510-a may occur via time resources between 0 and Tₛ, and the last (e.g., second) peaky transmission 515-a may occur via time resources defined by the duty cycle and the duty cycle value θ₁ (e.g., the duty cycle defined by

$$\frac{{T}_{s}}{{θ}_{1}} ) .$$

The network may also transmit a repetition 520-b of the same packet according to the same duty cycle (e.g., the duty cycle defined by

$$\frac{{T}_{s}}{{θ}_{1}} ) ,$$

where the first peaky transmission 510-b is transmitted via time resources between T₁ and T₁+Tₛ, and the second (e.g., last) peaky transmission 515-b is transmitted via time resources defined by the duty cycle at

$${T}_{1} + \frac{{T}_{1}}{{θ}_{1}} ) .$$

Transmitting peaking transmissions according to a duty cycle defined based on the duty cycle value θ₁ (e.g., a smaller duty cycle with a larger duty cycle value) may result in higher rates and less reliability. However, the reliability may be improved by transmitting the additional repetitions (e.g., at least the repetition 520-a and the repetition 520-b). In some examples, the devices may determine to avoid retransmission in case of energy-constrained devices (e.g., if the UE reports limited energy budge in the KPIs, the network entity may avoid scheduling repetitions of peaky transmissions).

In some examples, the network entity may configure a largest duty cycle (e.g., a smaller duty cycle value θ₂ where θ₂<θ₁, resulting in lower rates, but increased reliability. In such examples, energy efficiency may be achieved by avoiding retransmission (e.g., and provide reliability by adjusting the duty cycle). For example, transmission of multiple repetitions (e.g., the repetition 525-a and the repetition 525-b) according to the duty cycle having a duty cycle value of θ₂ may result in transmission of a peaky transmission (e.g., the peaky transmission 515-d) after the delay constraint T_{d,max}. For instance, if the network entity transmits multiple repetitions 525 according to the duty cycle value θ₂, the first peaky transmission 510-c may occur via time resources between 0 and Tₛ, and the last (e.g., second) peaky transmission 515-c may occur via time resources defined by the duty cycle and the duty cycle value θ₂ (e.g., the duty cycle defined by

$$\frac{{T}_{s}}{{θ}_{2}} ) .$$

The network may also transmit a repetition 525-b of the same packet according to the same duty cycle (e.g., the duty cycle defined by

$$\frac{{T}_{s}}{{θ}_{2}} ) ,$$

where the first peaky transmission 510-d is transmitted via time resources between T₂ and T₂+Tₛ, and the second (e.g., last) peaky transmission 515-d is transmitted via time resources defined by the duty cycle at

$${T}_{2} + \frac{{T}_{2}}{{θ}_{2}} ) .$$

Transmitting peaking transmissions according to a duty cycle defined based on the duty cycle value θ₂ (e.g., a larger duty cycle with a smaller duty cycle value) may result in lower rates and increased reliability (e.g., for transmission of a single repetition 525-a, where the second repetition 525-b cannot be transmitted within the delay constraint). In some examples, upon determining that one or more portions of a repetition 525-b will not satisfy the delay constraint, the network entity may determine not to configure multiple repetitions of a packet, and may instead set the duty cycle to improve throughout without violating a reliability threshold (e.g., in some cases, according to techniques described with reference to FIG. 4).

The network entity may configure the UE with duty cycle information, which may include a duty cycle value θ, an indication of one or more transmission occasions during which to transmit the peaky transmissions, time and resource information indicating when to transmit the peaky transmissions, a duration of a duty cycle, a quantity of repetitions, an indication of whether repetitions are configured for the peaky transmissions, or any combination thereof.

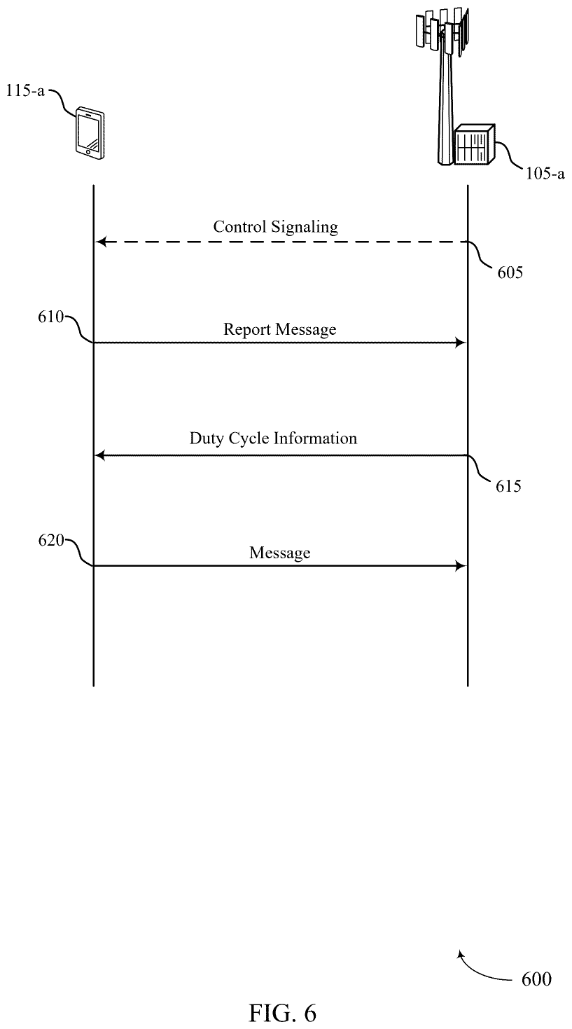

FIG. 6 shows an example of a process flow 600 that supports reliable non-coherent transmissions in accordance with one or more aspects of the present disclosure. The process flow 600 may implement, or be implemented by, aspects of the wireless communications system 100, the timeline 200, the timeline 300, the timeline 400, and the timeline 500. For example, the process flow 600 may include a UE 115-a and a network entity 105, which may be examples of corresponding devices described with reference to FIGS. 1-5). In examples described herein, the network entity 105-a may schedule peaky transmissions by the UE 115-a. However, techniques described herein with reference to FIGS. 2-6 may similarly be applied when the network entity schedules downlink peaky transmissions by the network entity 105-a to the UE 115-a.

At 610, the UE 115-a may transmit (e.g., to the network entity 105-a) a report message. The report message may include one or more performance parameters (e.g., KPIs). For example, the report message may include an indication of an energy threshold (e.g., a threshold energy expenditure the UE 115-a is capable of supporting), for non-coherent (e.g., peaky) transmissions, an energy budget, a delay constraint (e.g., a time duration during which a packet is to be transmitted via one or more non-coherent transmissions), or the like.

At 615, the UE 115-a may receive (e.g., from the network entity 105-a) based at least in part on the performance parameters, duty cycle information for non-coherent transmission. The duty cycle information may include a duty cycle value, and a peak transmission power for transmitting the message may be equal to an average transmission power divided by the duty cycle value.

In some examples (e.g., as described in greater detail with reference to FIG. 4), the duty cycle information my include a duty cycle value that corresponds to a first transmission occasion of the one or more transmission occasions occurring within the duty cycle, and a second transmission occasion of the one or more transmission occasions occurring with the duty cycle, the second transmission occasion occurring in a last available transmission occasion prior to expiration of the delay constraint. IN some examples, the duty cycle information may include an indication of a last transmission occasion of the one or more transmission occasions occurring within the duty cycle.

In some examples, the UE 115-a may receive control signaling (e.g., at 605) indicating a set of candidate transmission occasions, and the duty cycle information may include an indication of the last transmission occasion from the set of candidate transmission occasions. In some examples, the UE 115-a may receive control signaling (e.g., at 605) indicating a lookup table including multiple index values and a multiple candidate duty cycle values. Each index value may correspond to a respective candidate duty cycle value of the multiple candidate duty cycle values. The duty cycle information received at 615 may include an index value of the plurality of index values indicating a first duty cycle value corresponding to the duty cycle.

In some examples, the UE 115-a may receive control signaling (e.g., at 605) indicating whether the UE 115-a is to transmit one or more repetitions of the message during the duty cycle, wherein transmitting the message at 620 is based at least in part on receiving the control signaling.

At 620, the UE 115-a may transmit a message via one or more transmission occasions according to a duty cycle that is based at least in part on the duty cycle information. In some examples, transmitting the message may include transmitting the message via multiple non-coherent transmissions. For example, the UE 115-a may transmit a first portion of the message via a first transmission occasion (e.g., a first pulse or a first peaky transmission) and a second portion of the message via a second transmission occasion (e.g., a second pulse or a second peaky transmission).

In some examples, at 620, the UE 115-a may transmit a message (e.g., a first repetition) via a first set of transmission occasions, and a repetition of the message (e.g., at least a second repetition) via a second set of transmission occasions (e.g., as described in greater detail with reference to FIG. 5). In such examples, the first set of transmission occasions and the second set of transmission occasions may occur within the duty cycle according to the duty cycle information. In such examples, the first set of transmission occasions may occur according to a first duty cycle, and the second set of transmission occasions may occur within the duty cycle according to the duty cycle information, and both repetitions may be transmitted (e.g., according to the first duty cycle applied to each repetition) before expiration of the delay constraint (e.g., within the delay constraint).

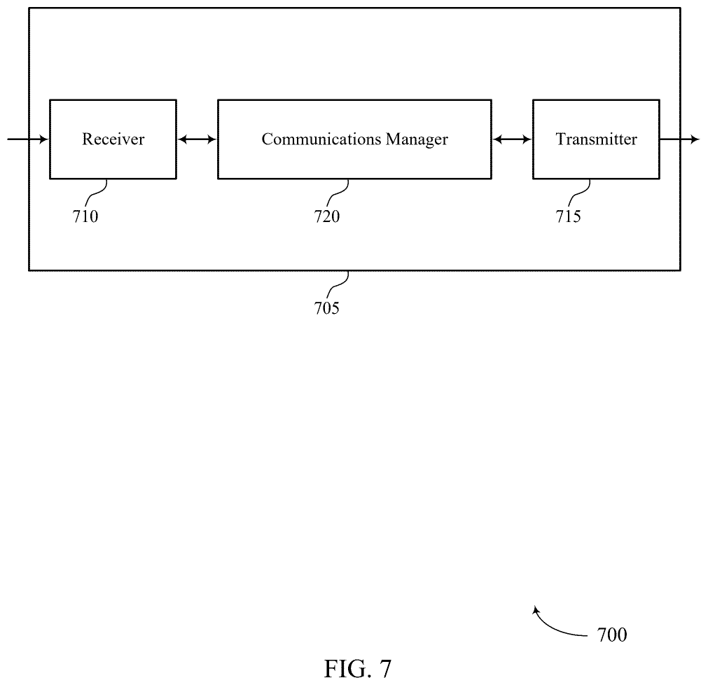

FIG. 7 shows a block diagram 700 of a device 705 that supports reliable non-coherent transmissions in accordance with one or more aspects of the present disclosure. The device 705 may be an example of aspects of a UE 115 as described herein. The device 705 may include a receiver 710, a transmitter 715, and a communications manager 720. The device 705, or one or more components of the device 705 (e.g., the receiver 710, the transmitter 715, the communications manager 720), may include at least one processor, which may be coupled with at least one memory, to, individually or collectively, support or enable the described techniques. Each of these components may be in communication with one another (e.g., via one or more buses).

The receiver 710 may provide a means for receiving information such as packets, user data, control information, or any combination thereof associated with various information channels (e.g., control channels, data channels, information channels related to reliable non-coherent transmissions). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to reliable non-coherent transmissions). In some examples, the transmitter 715 may be co-located with a receiver 710 in a transceiver module. The transmitter 715 may utilize a single antenna or a set of multiple antennas.

The communications manager 720, the receiver 710, the transmitter 715, or various combinations or components thereof may be examples of means for performing various aspects of reliable non-coherent transmissions as described herein. For example, the communications manager 720, the receiver 710, the transmitter 715, or various combinations or components thereof may be capable of performing one or more of the functions described herein.

In some examples, the communications manager 720, the receiver 710, the transmitter 715, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 720, the receiver 710, the transmitter 715, or various combinations or components thereof may be implemented in code (e.g., as communications management software) executed by at least one processor (e.g., referred to as a processor-executable code). If implemented in code executed by at least one processor, the functions of the communications manager 720, the receiver 710, the transmitter 715, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 720 may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications in accordance with examples as disclosed herein. For example, the communications manager 720 is capable of, configured to, or operable to support a means for transmitting a report message including an indication of one or more performance parameters including at least one of an energy threshold for non-coherent transmission, and a delay constraint for non-coherent transmission. The communications manager 720 is capable of, configured to, or operable to support a means for receiving, based on the one or more performance parameters, duty cycle information for non-coherent transmission. The communications manager 720 is capable of, configured to, or operable to support a means for transmitting a message via one or more transmission occasions according to a duty cycle that is based on the duty cycle information.

By including or configuring the communications manager 720 in accordance with examples as described herein, the device 705 (e.g., at least one processor controlling or otherwise coupled with the receiver 710, the transmitter 715, the communications manager 720, or a combination thereof) may support techniques for non-coherent transmission resulting in improved rates, improved throughput, decreased latency, and more efficient utilization of communication resources.

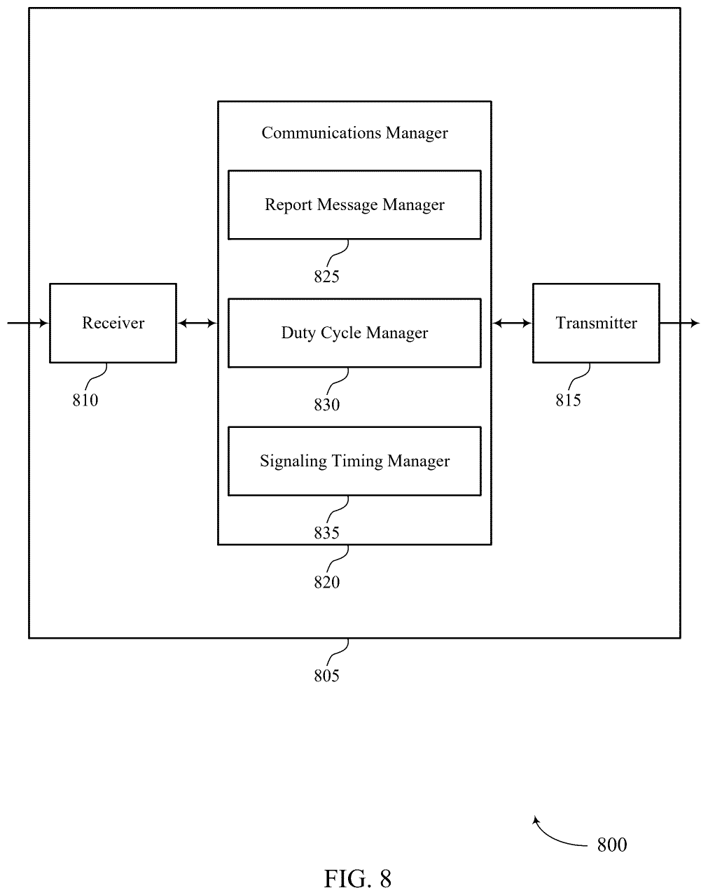

FIG. 8 shows a block diagram 800 of a device 805 that supports reliable non-coherent transmissions in accordance with one or more aspects of the present disclosure. The device 805 may be an example of aspects of a device 705 or a UE 115 as described herein. The device 805 may include a receiver 810, a transmitter 815, and a communications manager 820. The device 805, or one of more components of the device 805 (e.g., the receiver 810, the transmitter 815, the communications manager 820), may include at least one processor, which may be coupled with at least one memory, to support the described techniques. Each of these components may be in communication with one another (e.g., via one or more buses).

The receiver 810 may provide a means for receiving information such as packets, user data, control information, or any combination thereof associated with various information channels (e.g., control channels, data channels, information channels related to reliable non-coherent transmissions). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to reliable non-coherent transmissions). In some examples, the transmitter 815 may be co-located with a receiver 810 in a transceiver module. The transmitter 815 may utilize a single antenna or a set of multiple antennas.

The device 805, or various components thereof, may be an example of means for performing various aspects of reliable non-coherent transmissions as described herein. For example, the communications manager 820 may include a report message manager 825, a duty cycle manager 830, a signaling timing manager 835, or any combination thereof. The communications manager 820 may be an example of aspects of a communications manager 720 as described herein. In some examples, the communications manager 820, or various components thereof, may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communications in accordance with examples as disclosed herein. The report message manager 825 is capable of, configured to, or operable to support a means for transmitting a report message including an indication of one or more performance parameters including at least one of an energy threshold for non-coherent transmission, and a delay constraint for non-coherent transmission. The duty cycle manager 830 is capable of, configured to, or operable to support a means for receiving, based on the one or more performance parameters, duty cycle information for non-coherent transmission. The signaling timing manager 835 is capable of, configured to, or operable to support a means for transmitting a message via one or more transmission occasions according to a duty cycle that is based on the duty cycle information.

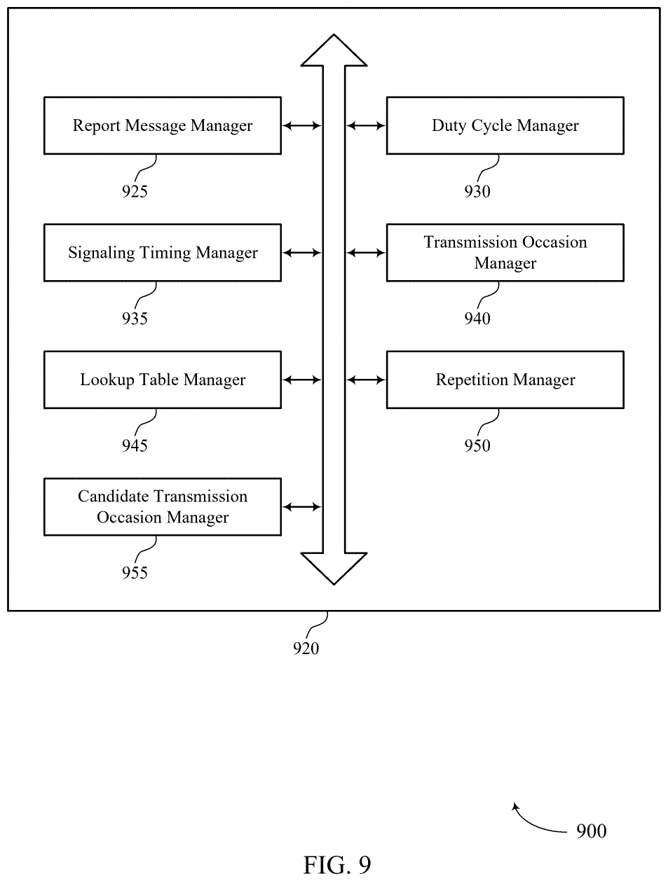

FIG. 9 shows a block diagram 900 of a communications manager 920 that supports reliable non-coherent transmissions in accordance with one or more aspects of the present disclosure. The communications manager 920 may be an example of aspects of a communications manager 720, a communications manager 820, or both, as described herein. The communications manager 920, or various components thereof, may be an example of means for performing various aspects of reliable non-coherent transmissions as described herein. For example, the communications manager 920 may include a report message manager 925, a duty cycle manager 930, a signaling timing manager 935, a transmission occasion manager 940, a lookup table manager 945, a repetition manager 950, a candidate transmission occasion manager 955, or any combination thereof. Each of these components, or components or subcomponents thereof (e.g., one or more processors, one or more memories), may communicate, directly or indirectly, with one another (e.g., via one or more buses).

The communications manager 920 may support wireless communications in accordance with examples as disclosed herein. The report message manager 925 is capable of, configured to, or operable to support a means for transmitting a report message including an indication of one or more performance parameters including at least one of an energy threshold for non-coherent transmission, and a delay constraint for non-coherent transmission. The duty cycle manager 930 is capable of, configured to, or operable to support a means for receiving, based on the one or more performance parameters, duty cycle information for non-coherent transmission. The signaling timing manager 935 is capable of, configured to, or operable to support a means for transmitting a message via one or more transmission occasions according to a duty cycle that is based on the duty cycle information.

In some examples, to support transmitting the message, the transmission occasion manager 940 is capable of, configured to, or operable to support a means for transmitting a first portion of the message via a first transmission occasion of the one or more transmission occasions, the first transmission occasion including a first set of time resources and a first set of frequency resources. In some examples, to support transmitting the message, the transmission occasion manager 940 is capable of, configured to, or operable to support a means for transmitting a second portion of the message via a second transmission occasion of the one or more transmission occasions, the second transmission occasion including a second set of time resources and a second set of frequency resources, where the second set of time resources is offset from the first set of time resources by a time duration according to the duty cycle.

In some examples, the duty cycle information includes a duty cycle value. In some examples, a peak transmission power for transmitting the message is equal to an average transmission power divided by the duty cycle value.

In some examples, the duty cycle information includes a duty cycle value that corresponds to a first transmission occasion of the one or more transmission occasions occurring within the duty cycle, and a second transmission occasion of the one or more transmission occasions occurring with the duty cycle, the second transmission occasion occurring in a last available transmission occasion prior to expiration of the delay constraint.

In some examples, the duty cycle information includes an indication of a last transmission occasion of the one or more transmission occasions occurring within the duty cycle.

In some examples, the candidate transmission occasion manager 955 is capable of, configured to, or operable to support a means for receiving control signaling indicating a set of multiple candidate transmission occasions, where the duty cycle information includes an indication of the last transmission occasion from the set of multiple candidate transmission occasions.

In some examples, the lookup table manager 945 is capable of, configured to, or operable to support a means for receiving control signaling indicating a lookup table including a set of multiple index values and a set of multiple candidate duty cycle values, each index value of the set of multiple index values corresponding to a respective candidate duty cycle value of the set of multiple candidate duty cycle values, where the duty cycle information includes an index value of the set of multiple index values indicating a first duty cycle value corresponding to the duty cycle.

In some examples, the duty cycle manager 930 is capable of, configured to, or operable to support a means for receiving control signaling indicating whether the wireless device is to transmit one or more repetitions of the message during the duty cycle, where transmitting the message is based on receiving the control signaling.

In some examples, to support transmitting the message, the repetition manager 950 is capable of, configured to, or operable to support a means for transmitting the message via a first set of transmission occasions. In some examples, to support transmitting the message, the repetition manager 950 is capable of, configured to, or operable to support a means for transmitting a repetition of the message via a second set of transmission occasions, where the first set of transmission occasions and the second set of transmission occasions occur within the duty cycle according to the duty cycle information.

In some examples, the first set of transmission occasions and the second set of transmission occasions of the duty cycle satisfy the delay constraint.

In some examples, transmitting the message includes transmitting one or more non-coherent peaky transmissions.

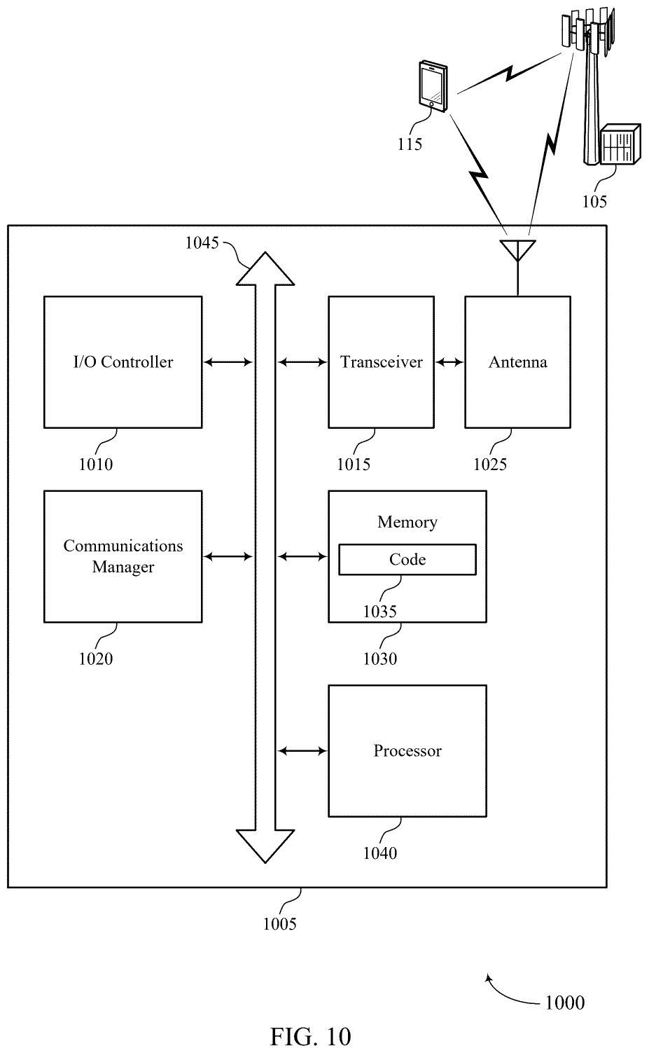

FIG. 10 shows a diagram of a system 1000 including a device 1005 that supports reliable non-coherent transmissions in accordance with one or more aspects of the present disclosure. The device 1005 may be an example of or include components of a device 705, a device 805, or a UE 115 as described herein. The device 1005 may communicate (e.g., wirelessly) with one or more other devices (e.g., network entities 105, UEs 115, or a combination thereof). The device 1005 may include components for bi-directional voice and data communications including components for transmitting and receiving communications, such as a communications manager 1020, an input/output (I/O) controller, such as an I/O controller 1010, a transceiver 1015, one or more antennas 1025, at least one memory 1030, code 1035, and at least one processor 1040. These components may be in electronic communication or otherwise coupled (e.g., operatively, communicatively, functionally, electronically, electrically) via one or more buses (e.g., a bus 1045).

The I/O controller 1010 may manage input and output signals for the device 1005. The I/O controller 1010 may also manage peripherals not integrated into the device 1005. In some cases, the I/O controller 1010 may represent a physical connection or port to an external peripheral. In some cases, the I/O controller 1010 may utilize an operating system such as iOS®, ANDROID®, MS-DOS®, MS-WINDOWS®, OS/2®, UNIX®, LINUX®, or another known operating system. Additionally, or alternatively, the I/O controller 1010 may represent or interact with a modem, a keyboard, a mouse, a touchscreen, or a similar device. In some cases, the I/O controller 1010 may be implemented as part of one or more processors, such as the at least one processor 1040. In some cases, a user may interact with the device 1005 via the I/O controller 1010 or via hardware components controlled by the I/O controller 1010.

In some cases, the device 1005 may include a single antenna. However, in some other cases, the device 1005 may have more than one antenna, which may be capable of concurrently transmitting or receiving multiple wireless transmissions. The transceiver 1015 may communicate bi-directionally via the one or more antennas 1025 using wired or wireless links as described herein. For example, the transceiver 1015 may represent a wireless transceiver and may communicate bi-directionally with another wireless transceiver. The transceiver 1015 may also include a modem to modulate the packets, to provide the modulated packets to one or more antennas 1025 for transmission, and to demodulate packets received from the one or more antennas 1025. The transceiver 1015, or the transceiver 1015 and one or more antennas 1025, may be an example of a transmitter 715, a transmitter 815, a receiver 710, a receiver 810, or any combination thereof or component thereof, as described herein.

The at least one memory 1030 may include random access memory (RAM) and read-only memory (ROM). The at least one memory 1030 may store computer-readable, computer-executable, or processor-executable code, such as the code 1035. The code 1035 may include instructions that, when executed by the at least one processor 1040, cause the device 1005 to perform various functions described herein. The code 1035 may be stored in a non-transitory computer-readable medium such as system memory or another type of memory. In some cases, the code 1035 may not be directly executable by the at least one processor 1040 but may cause a computer (e.g., when compiled and executed) to perform functions described herein. In some cases, the at least one memory 1030 may include, among other things, a basic I/O system (BIOS) which may control basic hardware or software operation such as the interaction with peripheral components or devices.

The at least one processor 1040 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1040 may be configured to operate a memory array using a memory controller. In some other cases, a memory controller may be integrated into the at least one processor 1040. The at least one processor 1040 may be configured to execute computer-readable instructions stored in a memory (e.g., the at least one memory 1030) to cause the device 1005 to perform various functions (e.g., functions or tasks supporting reliable non-coherent transmissions). For example, the device 1005 or a component of the device 1005 may include at least one processor 1040 and at least one memory 1030 coupled with or to the at least one processor 1040, the at least one processor 1040 and the at least one memory 1030 configured to perform various functions described herein.

In some examples, the at least one processor 1040 may include multiple processors and the at least one memory 1030 may include multiple memories. One or more of the multiple processors may be coupled with one or more of the multiple memories, which may, individually or collectively, be configured to perform various functions described herein. In some examples, the at least one processor 1040 may be a component of a processing system, which may refer to a system (such as a series) of machines, circuitry (including, for example, one or both of processor circuitry (which may include the at least one processor 1040) and memory circuitry (which may include the at least one memory 1030)), or components, that receives or obtains inputs and processes the inputs to produce, generate, or obtain a set of outputs. The processing system may be configured to perform one or more of the functions described herein. For example, the at least one processor 1040 or a processing system including the at least one processor 1040 may be configured to, configurable to, or operable to cause the device 1005 to perform one or more of the functions described herein. Further, as described herein, being “configured to,” being “configurable to,” and being “operable to” may be used interchangeably and may be associated with a capability, when executing code 1035 (e.g., processor-executable code) stored in the at least one memory 1030 or otherwise, to perform one or more of the functions described herein.

The communications manager 1020 may support wireless communications in accordance with examples as disclosed herein. For example, the communications manager 1020 is capable of, configured to, or operable to support a means for transmitting a report message including an indication of one or more performance parameters including at least one of an energy threshold for non-coherent transmission, and a delay constraint for non-coherent transmission. The communications manager 1020 is capable of, configured to, or operable to support a means for receiving, based on the one or more performance parameters, duty cycle information for non-coherent transmission. The communications manager 1020 is capable of, configured to, or operable to support a means for transmitting a message via one or more transmission occasions according to a duty cycle that is based on the duty cycle information.

By including or configuring the communications manager 1020 in accordance with examples as described herein, the device 1005 may support techniques for non-coherent transmission resulting in improved rates, improved throughput, decreased latency, reduced power consumption, improved coordination between devices and more efficient utilization of communication resources.

In some examples, the communications manager 1020 may be configured to perform various operations (e.g., receiving, monitoring, transmitting) using or otherwise in cooperation with the transceiver 1015, the one or more antennas 1025, or any combination thereof. Although the communications manager 1020 is illustrated as a separate component, in some examples, one or more functions described with reference to the communications manager 1020 may be supported by or performed by the at least one processor 1040, the at least one memory 1030, the code 1035, or any combination thereof. For example, the code 1035 may include instructions executable by the at least one processor 1040 to cause the device 1005 to perform various aspects of reliable non-coherent transmissions as described herein, or the at least one processor 1040 and the at least one memory 1030 may be otherwise configured to, individually or collectively, perform or support such operations.

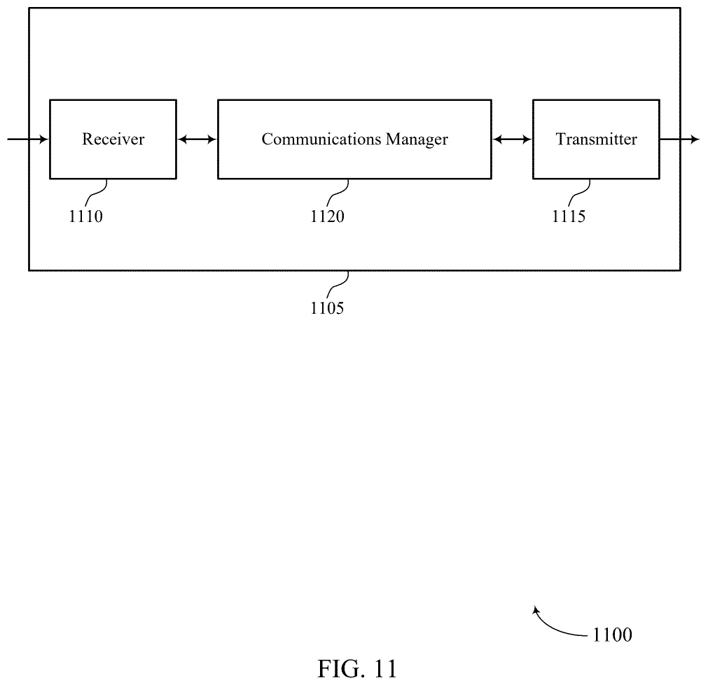

FIG. 11 shows a block diagram 1100 of a device 1105 that supports reliable non-coherent transmissions in accordance with one or more aspects of the present disclosure. The device 1105 may be an example of aspects of a network entity 105 as described herein. The device 1105 may include a receiver 1110, a transmitter 1115, and a communications manager 1120. The device 1105, or one or more components of the device 1105 (e.g., the receiver 1110, the transmitter 1115, the communications manager 1120), may include at least one processor, which may be coupled with at least one memory, to, individually or collectively, support or enable the described techniques. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The communications manager 1120, the receiver 1110, the transmitter 1115, or various combinations or components thereof may be examples of means for performing various aspects of reliable non-coherent transmissions as described herein. For example, the communications manager 1120, the receiver 1110, the transmitter 1115, or various combinations or components thereof may be capable of performing one or more of the functions described herein.

In some examples, the communications manager 1120, the receiver 1110, the transmitter 1115, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1120, the receiver 1110, the transmitter 1115, or various combinations or components thereof may be implemented in code (e.g., as communications management software) executed by at least one processor (e.g., referred to as a processor-executable code). If implemented in code executed by at least one processor, the functions of the communications manager 1120, the receiver 1110, the transmitter 1115, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1120 may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communications in accordance with examples as disclosed herein. For example, the communications manager 1120 is capable of, configured to, or operable to support a means for receiving a report message including an indication of one or more performance parameters including at least one of an energy threshold for non-coherent transmission by a second wireless device, and a delay constraint for non-coherent transmission by the second wireless device. The communications manager 1120 is capable of, configured to, or operable to support a means for transmitting, based on the one or more performance parameters, duty cycle information for non-coherent transmissions. The communications manager 1120 is capable of, configured to, or operable to support a means for receiving a message via one or more transmission occasions according to a duty cycle that is based on the duty cycle information.

By including or configuring the communications manager 1120 in accordance with examples as described herein, the device 1105 (e.g., at least one processor controlling or otherwise coupled with the receiver 1110, the transmitter 1115, the communications manager 1120, or a combination thereof) may support techniques for non-coherent transmission resulting in improved rates, improved throughput, decreased latency, and more efficient utilization of communication resources.

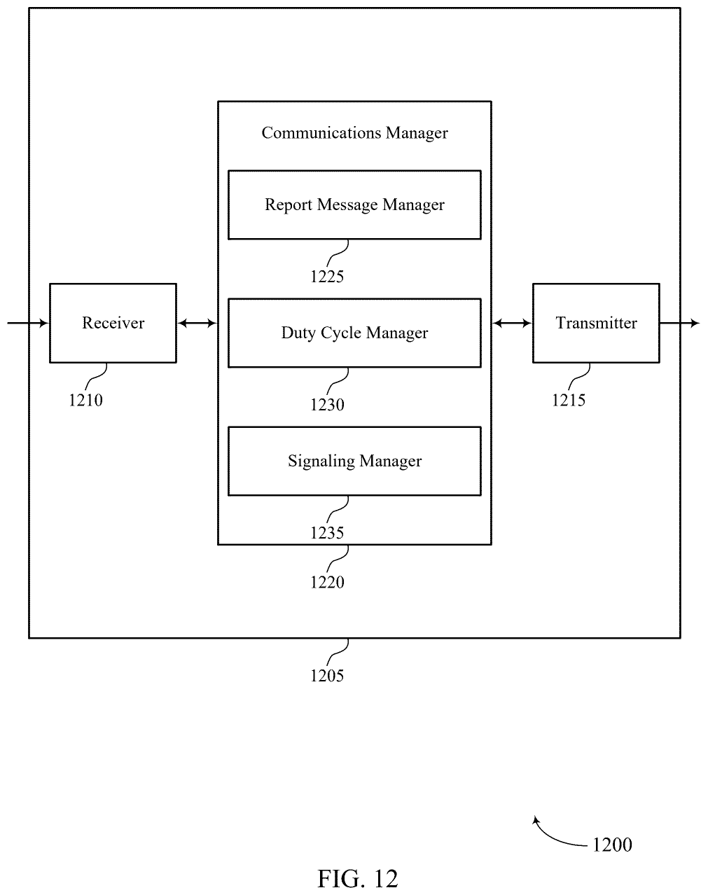

FIG. 12 shows a block diagram 1200 of a device 1205 that supports reliable non-coherent transmissions in accordance with one or more aspects of the present disclosure. The device 1205 may be an example of aspects of a device 1105 or a network entity 105 as described herein. The device 1205 may include a receiver 1210, a transmitter 1215, and a communications manager 1220. The device 1205, or one of more components of the device 1205 (e.g., the receiver 1210, the transmitter 1215, the communications manager 1220), may include at least one processor, which may be coupled with at least one memory, to support the described techniques. Each of these components may be in communication with one another (e.g., via one or more buses).

The receiver 1210 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1205. In some examples, the receiver 1210 may support obtaining information by receiving signals via one or more antennas. Additionally, or alternatively, the receiver 1210 may support obtaining information by receiving signals via one or more wired (e.g., electrical, fiber optic) interfaces, wireless interfaces, or any combination thereof.

The transmitter 1215 may provide a means for outputting (e.g., transmitting, providing, conveying, sending) information generated by other components of the device 1205. For example, the transmitter 1215 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1215 may support outputting information by transmitting signals via one or more antennas. Additionally, or alternatively, the transmitter 1215 may support outputting information by transmitting signals via one or more wired (e.g., electrical, fiber optic) interfaces, wireless interfaces, or any combination thereof. In some examples, the transmitter 1215 and the receiver 1210 may be co-located in a transceiver, which may include or be coupled with a modem.

The device 1205, or various components thereof, may be an example of means for performing various aspects of reliable non-coherent transmissions as described herein. For example, the communications manager 1220 may include a report message manager 1225, a duty cycle manager 1230, a signaling manager 1235, or any combination thereof. The communications manager 1220 may be an example of aspects of a communications manager 1120 as described herein. In some examples, the communications manager 1220, or various components thereof, may be configured to perform various operations (e.g., receiving, obtaining, monitoring, outputting, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to obtain information, output information, or perform various other operations as described herein.

The communications manager 1220 may support wireless communications in accordance with examples as disclosed herein. The report message manager 1225 is capable of, configured to, or operable to support a means for receiving a report message including an indication of one or more performance parameters including at least one of an energy threshold for non-coherent transmission by a second wireless device, and a delay constraint for non-coherent transmission by the second wireless device. The duty cycle manager 1230 is capable of, configured to, or operable to support a means for transmitting, based on the one or more performance parameters, duty cycle information for non-coherent transmissions. The signaling manager 1235 is capable of, configured to, or operable to support a means for receiving a message via one or more transmission occasions according to a duty cycle that is based on the duty cycle information.

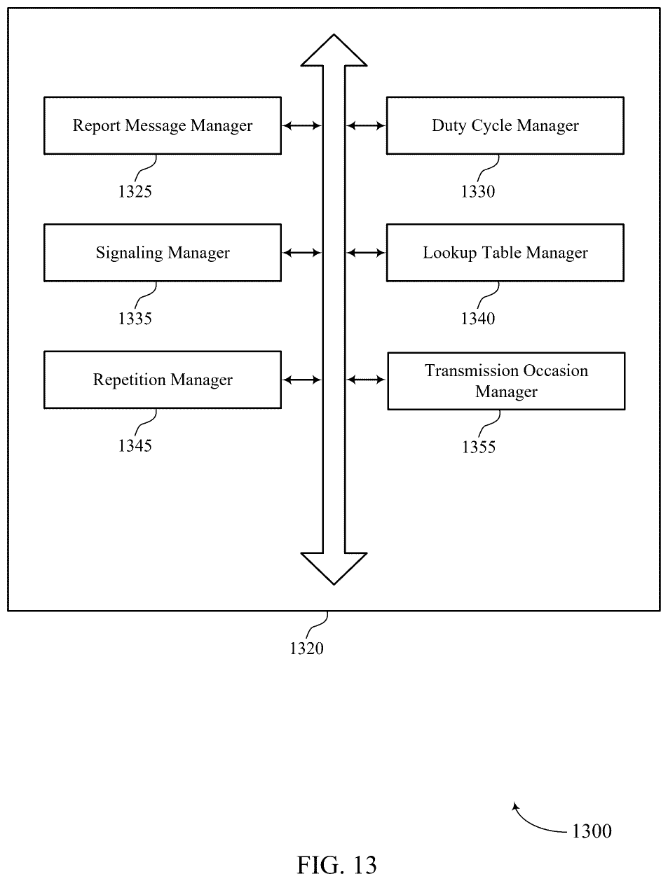

FIG. 13 shows a block diagram 1300 of a communications manager 1320 that supports reliable non-coherent transmissions in accordance with one or more aspects of the present disclosure. The communications manager 1320 may be an example of aspects of a communications manager 1120, a communications manager 1220, or both, as described herein. The communications manager 1320, or various components thereof, may be an example of means for performing various aspects of reliable non-coherent transmissions as described herein. For example, the communications manager 1320 may include a report message manager 1325, a duty cycle manager 1330, a signaling manager 1335, a lookup table manager 1340, a repetition manager 1345, a transmission occasion manager 1355, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1320 may support wireless communications in accordance with examples as disclosed herein. The report message manager 1325 is capable of, configured to, or operable to support a means for receiving a report message including an indication of one or more performance parameters including at least one of an energy threshold for non-coherent transmission by a second wireless device, and a delay constraint for non-coherent transmission by the second wireless device. The duty cycle manager 1330 is capable of, configured to, or operable to support a means for transmitting, based on the one or more performance parameters, duty cycle information for non-coherent transmissions. The signaling manager 1335 is capable of, configured to, or operable to support a means for receiving a message via one or more transmission occasions according to a duty cycle that is based on the duty cycle information.

In some examples, to support receiving the message, the duty cycle manager 1330 is capable of, configured to, or operable to support a means for receiving a first portion of the message via a first transmission occasion of the one or more transmission occasions, the first transmission occasion including a first set of time resources and a first set of frequency resources. In some examples, to support receiving the message, the duty cycle manager 1330 is capable of, configured to, or operable to support a means for receiving a second portion of the message via a second transmission occasion of the one or more transmission occasions, the second transmission occasion including a second set of time resources and a second set of frequency resources, where the second set of time resources is offset from the first set of time resources by a time duration according to the duty cycle.

In some examples, the duty cycle information includes a duty cycle value that corresponds to a first transmission occasion of the one or more transmission occasions occurring within the duty cycle, and a second transmission occasion of the one or more transmission occasions occurring with the duty cycle, the second transmission occasion occurring in a last available transmission occasion prior to expiration of a time duration indicated by the delay constraint.

In some examples, the duty cycle manager 1330 is capable of, configured to, or operable to support a means for selecting the duty cycle value from a set of multiple candidate duty cycle values based on the delay constraint, where the selected duty cycle value corresponds to the duty cycle having a duration that satisfies the delay constraint.

In some examples, the duty cycle information includes an indication of a last transmission occasion of the one or more transmission occasions occurring within the duty cycle.

In some examples, the transmission occasion manager 1355 is capable of, configured to, or operable to support a means for transmitting control signaling indicating a set of multiple candidate transmission occasions, where the duty cycle information includes an indication of the last transmission occasion from the set of multiple candidate transmission occasions.

In some examples, the transmission occasion manager 1355 is capable of, configured to, or operable to support a means for selecting the last transmission occasion from a set of multiple candidate transmission indications based on the last transmission occasion occurring prior to expiration of the delay constraint.

In some examples, the lookup table manager 1340 is capable of, configured to, or operable to support a means for transmitting control signaling indicating a lookup table including a set of multiple index values and a set of multiple candidate duty cycle values, each index value of the set of multiple index values corresponding to a respective candidate duty cycle value of the set of multiple candidate duty cycle values, where the duty cycle information includes an index value of the set of multiple index values indicating a first duty cycle value corresponding to the duty cycle.

In some examples, the repetition manager 1345 is capable of, configured to, or operable to support a means for transmitting control signaling indicating whether the wireless device is to transmit one or more repetitions of the message during the duty cycle, where receiving the message is based on receiving the control signaling.

In some examples, the repetition manager 1345 is capable of, configured to, or operable to support a means for determining, based on the one or more performance parameters, whether the wireless device is to transmit one or more repetitions of the message during the duty cycle, where transmitting the control signaling is based on the determining.

In some examples, the repetition manager 1345 is capable of, configured to, or operable to support a means for receiving the message via a first set of transmission occasions. In some examples, the repetition manager 1345 is capable of, configured to, or operable to support a means for receiving a repetition of the message via a second set of transmission occasions, where the first set of transmission occasions and the second set of transmission occasions occur within the duty cycle according to the duty cycle information.

In some examples, the first set of transmission occasions and the second set of transmission occasions of the duty cycle satisfy the delay constraint.

In some examples, transmitting the message includes transmitting one or more non-coherent peaky transmissions.

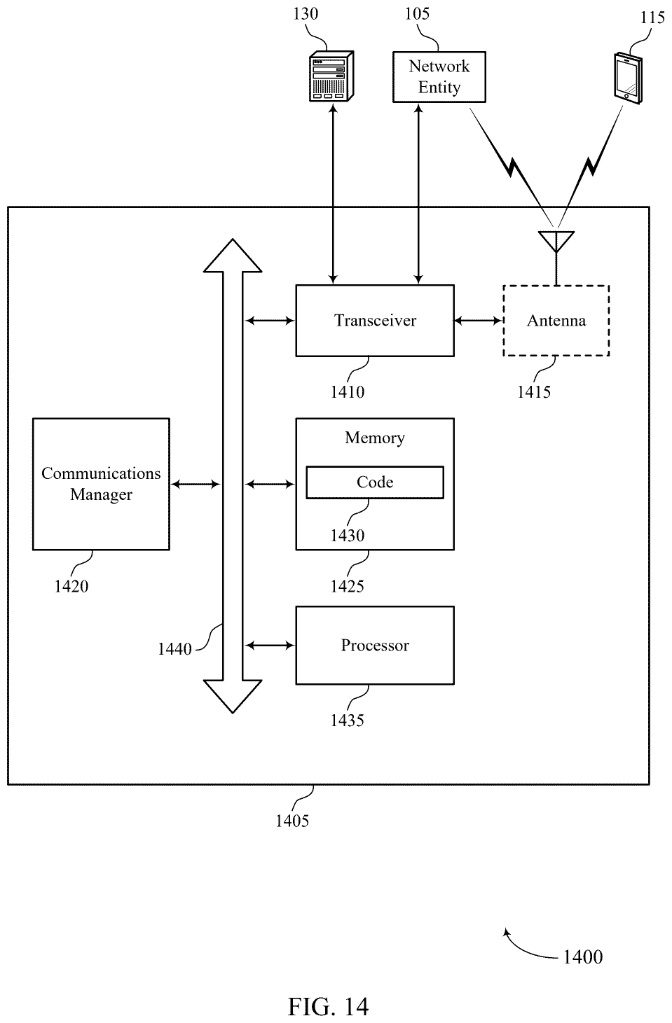

FIG. 14 shows a diagram of a system 1400 including a device 1405 that supports reliable non-coherent transmissions in accordance with one or more aspects of the present disclosure. The device 1405 may be an example of or include components of a device 1105, a device 1205, or a network entity 105 as described herein. The device 1405 may communicate with other network devices or network equipment such as one or more of the network entities 105, UEs 115, or any combination thereof. The communications may include communications over one or more wired interfaces, over one or more wireless interfaces, or any combination thereof. The device 1405 may include components that support outputting and obtaining communications, such as a communications manager 1420, a transceiver 1410, one or more antennas 1415, at least one memory 1425, code 1430, and at least one processor 1435. These components may be in electronic communication or otherwise coupled (e.g., operatively, communicatively, functionally, electronically, electrically) via one or more buses (e.g., a bus 1440).

The transceiver 1410 may support bi-directional communications via wired links, wireless links, or both as described herein. In some examples, the transceiver 1410 may include a wired transceiver and may communicate bi-directionally with another wired transceiver. Additionally, or alternatively, in some examples, the transceiver 1410 may include a wireless transceiver and may communicate bi-directionally with another wireless transceiver. In some examples, the device 1405 may include one or more antennas 1415, which may be capable of transmitting or receiving wireless transmissions (e.g., concurrently). The transceiver 1410 may also include a modem to modulate signals, to provide the modulated signals for transmission (e.g., by one or more antennas 1415, by a wired transmitter), to receive modulated signals (e.g., from one or more antennas 1415, from a wired receiver), and to demodulate signals. In some implementations, the transceiver 1410 may include one or more interfaces, such as one or more interfaces coupled with the one or more antennas 1415 that are configured to support various receiving or obtaining operations, or one or more interfaces coupled with the one or more antennas 1415 that are configured to support various transmitting or outputting operations, or a combination thereof. In some implementations, the transceiver 1410 may include or be configured for coupling with one or more processors or one or more memory components that are operable to perform or support operations based on received or obtained information or signals, or to generate information or other signals for transmission or other outputting, or any combination thereof. In some implementations, the transceiver 1410, or the transceiver 1410 and the one or more antennas 1415, or the transceiver 1410 and the one or more antennas 1415 and one or more processors or one or more memory components (e.g., the at least one processor 1435, the at least one memory 1425, or both), may be included in a chip or chip assembly that is installed in the device 1405. In some examples, the transceiver 1410 may be operable to support communications via one or more communications links (e.g., communication link(s) 125, backhaul communication link(s) 120, a midhaul communication link 162, a fronthaul communication link 168).

The at least one memory 1425 may include RAM, ROM, or any combination thereof. The at least one memory 1425 may store computer-readable, computer-executable, or processor-executable code, such as the code 1430. The code 1430 may include instructions that, when executed by one or more of the at least one processor 1435, cause the device 1405 to perform various functions described herein. The code 1430 may be stored in a non-transitory computer-readable medium such as system memory or another type of memory. In some cases, the code 1430 may not be directly executable by a processor of the at least one processor 1435 but may cause a computer (e.g., when compiled and executed) to perform functions described herein. In some cases, the at least one memory 1425 may include, among other things, a BIOS which may control basic hardware or software operation such as the interaction with peripheral components or devices. In some examples, the at least one processor 1435 may include multiple processors and the at least one memory 1425 may include multiple memories. One or more of the multiple processors may be coupled with one or more of the multiple memories which may, individually or collectively, be configured to perform various functions herein (for example, as part of a processing system).

The at least one processor 1435 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1435 may be configured to operate a memory array using a memory controller. In some other cases, a memory controller may be integrated into one or more of the at least one processor 1435. The at least one processor 1435 may be configured to execute computer-readable instructions stored in a memory (e.g., one or more of the at least one memory 1425) to cause the device 1405 to perform various functions (e.g., functions or tasks supporting reliable non-coherent transmissions). For example, the device 1405 or a component of the device 1405 may include at least one processor 1435 and at least one memory 1425 coupled with one or more of the at least one processor 1435, the at least one processor 1435 and the at least one memory 1425 configured to perform various functions described herein. The at least one processor 1435 may be an example of a cloud-computing platform (e.g., one or more physical nodes and supporting software such as operating systems, virtual machines, or container instances) that may host the functions (e.g., by executing code 1430) to perform the functions of the device 1405. The at least one processor 1435 may be any one or more suitable processors capable of executing scripts or instructions of one or more software programs stored in the device 1405 (such as within one or more of the at least one memory 1425).

In some examples, the at least one processor 1435 may include multiple processors and the at least one memory 1425 may include multiple memories. One or more of the multiple processors may be coupled with one or more of the multiple memories, which may, individually or collectively, be configured to perform various functions herein. In some examples, the at least one processor 1435 may be a component of a processing system, which may refer to a system (such as a series) of machines, circuitry (including, for example, one or both of processor circuitry (which may include the at least one processor 1435) and memory circuitry (which may include the at least one memory 1425)), or components, that receives or obtains inputs and processes the inputs to produce, generate, or obtain a set of outputs. The processing system may be configured to perform one or more of the functions described herein. For example, the at least one processor 1435 or a processing system including the at least one processor 1435 may be configured to, configurable to, or operable to cause the device 1405 to perform one or more of the functions described herein. Further, as described herein, being “configured to,” being “configurable to,” and being “operable to” may be used interchangeably and may be associated with a capability, when executing code stored in the at least one memory 1425 or otherwise, to perform one or more of the functions described herein.

In some examples, a bus 1440 may support communications of (e.g., within) a protocol layer of a protocol stack. In some examples, a bus 1440 may support communications associated with a logical channel of a protocol stack (e.g., between protocol layers of a protocol stack), which may include communications performed within a component of the device 1405, or between different components of the device 1405 that may be co-located or located in different locations (e.g., where the device 1405 may refer to a system in which one or more of the communications manager 1420, the transceiver 1410, the at least one memory 1425, the code 1430, and the at least one processor 1435 may be located in one of the different components or divided between different components).

In some examples, the communications manager 1420 may manage aspects of communications with a core network 130 (e.g., via one or more wired or wireless backhaul links). For example, the communications manager 1420 may manage the transfer of data communications for client devices, such as one or more UEs 115. In some examples, the communications manager 1420 may manage communications with one or more other network entities 105, and may include a controller or scheduler for controlling communications with UEs 115 (e.g., in cooperation with the one or more other network devices). In some examples, the communications manager 1420 may support an X2 interface within an LTE/LTE-A wireless communications network technology to provide communication between network entities 105.

The communications manager 1420 may support wireless communications in accordance with examples as disclosed herein. For example, the communications manager 1420 is capable of, configured to, or operable to support a means for receiving a report message including an indication of one or more performance parameters including at least one of an energy threshold for non-coherent transmission by a second wireless device, and a delay constraint for non-coherent transmission by the second wireless device. The communications manager 1420 is capable of, configured to, or operable to support a means for transmitting, based on the one or more performance parameters, duty cycle information for non-coherent transmissions. The communications manager 1420 is capable of, configured to, or operable to support a means for receiving a message via one or more transmission occasions according to a duty cycle that is based on the duty cycle information.

By including or configuring the communications manager 1420 in accordance with examples as described herein, the device 1405 may support techniques for non-coherent transmission resulting in improved rates, improved throughput, decreased latency, reduced power consumption, improved coordination between devices and more efficient utilization of communication resources.

In some examples, the communications manager 1420 may be configured to perform various operations (e.g., receiving, obtaining, monitoring, outputting, transmitting) using or otherwise in cooperation with the transceiver 1410, the one or more antennas 1415 (e.g., where applicable), or any combination thereof. Although the communications manager 1420 is illustrated as a separate component, in some examples, one or more functions described with reference to the communications manager 1420 may be supported by or performed by the transceiver 1410, one or more of the at least one processor 1435, one or more of the at least one memory 1425, the code 1430, or any combination thereof (for example, by a processing system including at least a portion of the at least one processor 1435, the at least one memory 1425, the code 1430, or any combination thereof). For example, the code 1430 may include instructions executable by one or more of the at least one processor 1435 to cause the device 1405 to perform various aspects of reliable non-coherent transmissions as described herein, or the at least one processor 1435 and the at least one memory 1425 may be otherwise configured to, individually or collectively, perform or support such operations.

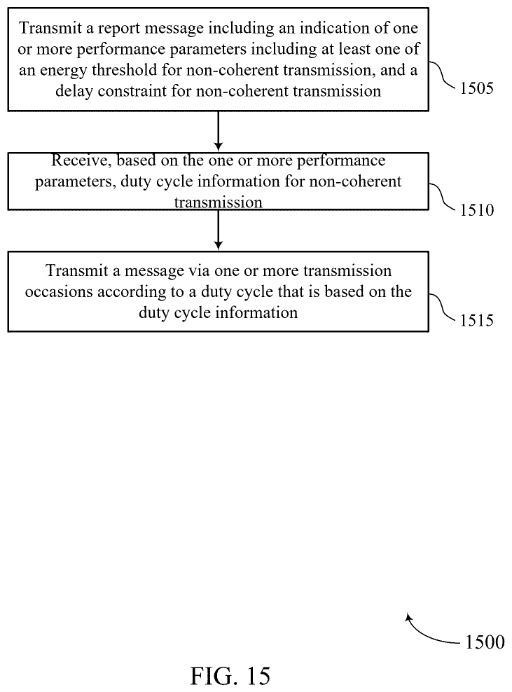

FIG. 15 shows a flowchart illustrating a method 1500 that supports reliable non-coherent transmissions in accordance with one or more aspects of the present disclosure. The operations of the method 1500 may be implemented by a UE or its components as described herein. For example, the operations of the method 1500 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1505, the method may include transmitting a report message including an indication of one or more performance parameters including at least one of an energy threshold for non-coherent transmission, and a delay constraint for non-coherent transmission. The operations of 1505 may be performed in accordance with examples as disclosed herein. In some examples, aspects of the operations of 1505 may be performed by a report message manager 925 as described with reference to FIG. 9.

At 1510, the method may include receiving, based on the one or more performance parameters, duty cycle information for non-coherent transmission. The operations of 1510 may be performed in accordance with examples as disclosed herein. In some examples, aspects of the operations of 1510 may be performed by a duty cycle manager 930 as described with reference to FIG. 9.

At 1515, the method may include transmitting a message via one or more transmission occasions according to a duty cycle that is based on the duty cycle information. The operations of 1515 may be performed in accordance with examples as disclosed herein. In some examples, aspects of the operations of 1515 may be performed by a signaling timing manager 935 as described with reference to FIG. 9.

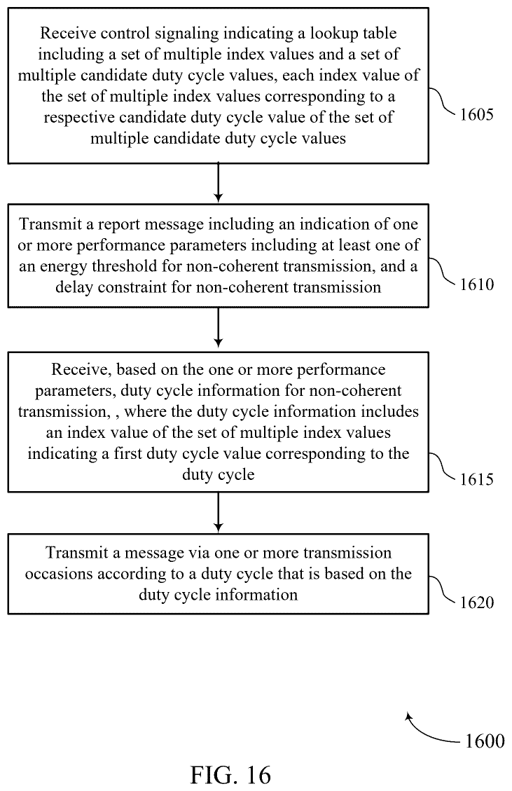

FIG. 16 shows a flowchart illustrating a method 1600 that supports reliable non-coherent transmissions in accordance with one or more aspects of the present disclosure. The operations of the method 1600 may be implemented by a UE or its components as described herein. For example, the operations of the method 1600 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1605, the method may include receiving control signaling indicating a lookup table including a set of multiple index values and a set of multiple candidate duty cycle values, each index value of the set of multiple index values corresponding to a respective candidate duty cycle value of the set of multiple candidate duty cycle values. The operations of 1605 may be performed in accordance with examples as disclosed herein. In some examples, aspects of the operations of 1605 may be performed by a lookup table manager 945 as described with reference to FIG. 9.

At 1610, the method may include transmitting a report message including an indication of one or more performance parameters including at least one of an energy threshold for non-coherent transmission, and a delay constraint for non-coherent transmission. The operations of 1610 may be performed in accordance with examples as disclosed herein. In some examples, aspects of the operations of 1610 may be performed by a report message manager 925 as described with reference to FIG. 9.

At 1615, the method may include receiving, based on the one or more performance parameters, duty cycle information for non-coherent transmission, where the duty cycle information includes an index value of the set of multiple index values indicating a first duty cycle value corresponding to the duty cycle. The operations of 1615 may be performed in accordance with examples as disclosed herein. In some examples, aspects of the operations of 1615 may be performed by a duty cycle manager 930 as described with reference to FIG. 9.

At 1620, the method may include transmitting a message via one or more transmission occasions according to a duty cycle that is based on the duty cycle information. The operations of 1620 may be performed in accordance with examples as disclosed herein. In some examples, aspects of the operations of 1620 may be performed by a signaling timing manager 935 as described with reference to FIG. 9.

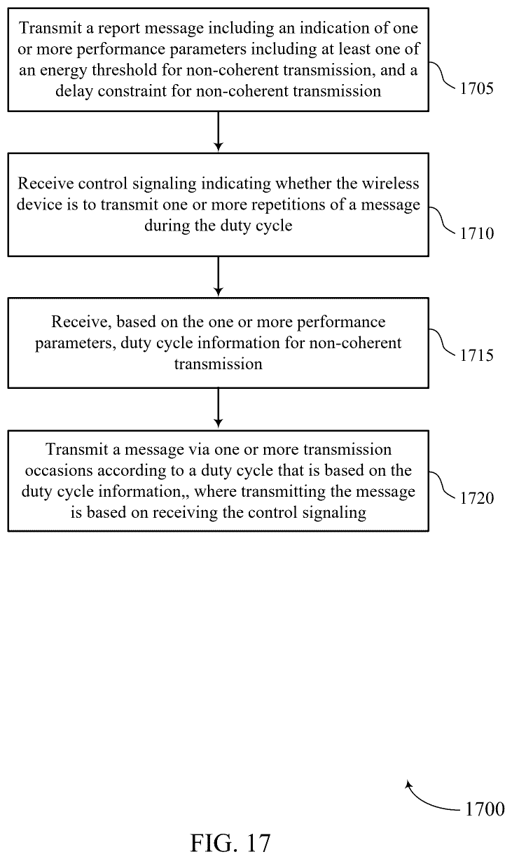

FIG. 17 shows a flowchart illustrating a method 1700 that supports reliable non-coherent transmissions in accordance with one or more aspects of the present disclosure. The operations of the method 1700 may be implemented by a UE or its components as described herein. For example, the operations of the method 1700 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1705, the method may include transmitting a report message including an indication of one or more performance parameters including at least one of an energy threshold for non-coherent transmission, and a delay constraint for non-coherent transmission. The operations of 1705 may be performed in accordance with examples as disclosed herein. In some examples, aspects of the operations of 1705 may be performed by a report message manager 925 as described with reference to FIG. 9.

At 1710, the method may include receiving control signaling indicating whether the wireless device is to transmit one or more repetitions of a message during the duty cycle. The operations of 1710 may be performed in accordance with examples as disclosed herein. In some examples, aspects of the operations of 1710 may be performed by a duty cycle manager 930 as described with reference to FIG. 9.

At 1715, the method may include receiving, based on the one or more performance parameters, duty cycle information for non-coherent transmission. The operations of 1715 may be performed in accordance with examples as disclosed herein. In some examples, aspects of the operations of 1715 may be performed by a duty cycle manager 930 as described with reference to FIG. 9.

At 1720, the method may include transmitting a message via one or more transmission occasions according to a duty cycle that is based on the duty cycle information, where transmitting the message is based on receiving the control signaling. The operations of 1720 may be performed in accordance with examples as disclosed herein. In some examples, aspects of the operations of 1720 may be performed by a signaling timing manager 935 as described with reference to FIG. 9.

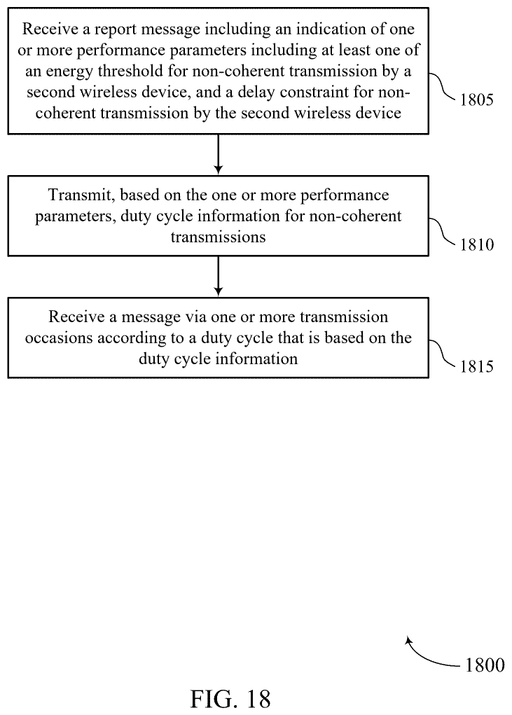

FIG. 18 shows a flowchart illustrating a method 1800 that supports reliable non-coherent transmissions in accordance with one or more aspects of the present disclosure. The operations of the method 1800 may be implemented by a network entity or its components as described herein. For example, the operations of the method 1800 may be performed by a network entity as described with reference to FIGS. 1 through 6 and 11 through 14. In some examples, a network entity may execute a set of instructions to control the functional elements of the network entity to perform the described functions. Additionally, or alternatively, the network entity may perform aspects of the described functions using special-purpose hardware.

At 1805, the method may include receiving a report message including an indication of one or more performance parameters including at least one of an energy threshold for non-coherent transmission by a second wireless device, and a delay constraint for non-coherent transmission by the second wireless device. The operations of 1805 may be performed in accordance with examples as disclosed herein. In some examples, aspects of the operations of 1805 may be performed by a report message manager 1325 as described with reference to FIG. 13.

At 1810, the method may include transmitting, based on the one or more performance parameters, duty cycle information for non-coherent transmissions. The operations of 1810 may be performed in accordance with examples as disclosed herein. In some examples, aspects of the operations of 1810 may be performed by a duty cycle manager 1330 as described with reference to FIG. 13.

At 1815, the method may include receiving a message via one or more transmission occasions according to a duty cycle that is based on the duty cycle information. The operations of 1815 may be performed in accordance with examples as disclosed herein. In some examples, aspects of the operations of 1815 may be performed by a signaling manager 1335 as described with reference to FIG. 13.

The following provides an overview of aspects of the present disclosure:

Aspect 1: A method for wireless communications at a wireless device, comprising: transmitting a report message comprising an indication of one or more performance parameters comprising at least one of an energy threshold for non-coherent transmission, and a delay constraint for non-coherent transmission; receiving, based at least in part on the one or more performance parameters, duty cycle information for non-coherent transmission; and transmitting a message via one or more transmission occasions according to a duty cycle that is based at least in part on the duty cycle information.

Aspect 2: The method of aspect 1, wherein transmitting the message comprises: transmitting a first portion of the message via a first transmission occasion of the one or more transmission occasions, the first transmission occasion comprising a first set of time resources and a first set of frequency resources; and transmitting a second portion of the message via a second transmission occasion of the one or more transmission occasions, the second transmission occasion comprising a second set of time resources and a second set of frequency resources, wherein the second set of time resources is offset from the first set of time resources by a time duration according to the duty cycle.

Aspect 3: The method of any of aspects 1 through 2, wherein the duty cycle information comprises a duty cycle value, and a peak transmission power for transmitting the message is equal to an average transmission power divided by the duty cycle value.

Aspect 4: The method of any of aspects 1 through 3, wherein the duty cycle information comprises a duty cycle value that corresponds to a first transmission occasion of the one or more transmission occasions occurring within the duty cycle, and a second transmission occasion of the one or more transmission occasions occurring with the duty cycle, the second transmission occasion occurring in a last available transmission occasion prior to expiration of the delay constraint.

Aspect 5: The method of any of aspects 1 through 4, wherein the duty cycle information comprises an indication of a last transmission occasion of the one or more transmission occasions occurring within the duty cycle.

Aspect 6: The method of aspect 5, further comprising: receiving control signaling indicating a plurality of candidate transmission occasions, wherein the duty cycle information comprises an indication of the last transmission occasion from the plurality of candidate transmission occasions.

Aspect 7: The method of any of aspects 1 through 6, further comprising: receiving control signaling indicating a lookup table comprising a plurality of index values and a plurality of candidate duty cycle values, each index value of the plurality of index values corresponding to a respective candidate duty cycle value of the plurality of candidate duty cycle values, wherein the duty cycle information comprises an index value of the plurality of index values indicating a first duty cycle value corresponding to the duty cycle.

Aspect 8: The method of any of aspects 1 through 7, further comprising: receiving control signaling indicating whether the wireless device is to transmit one or more repetitions of the message during the duty cycle, wherein transmitting the message is based at least in part on receiving the control signaling.

Aspect 9: The method of any of aspects 1 through 8, wherein transmitting the message comprises: transmitting the message via a first set of transmission occasions; and transmitting a repetition of the message via a second set of transmission occasions, wherein the first set of transmission occasions and the second set of transmission occasions occur within the duty cycle according to the duty cycle information.

Aspect 10: The method of aspect 9, wherein the first set of transmission occasions and the second set of transmission occasions of the duty cycle satisfy the delay constraint.

Aspect 11: The method of any of aspects 1 through 10, wherein transmitting the message comprises transmitting one or more non-coherent peaky transmissions.

Aspect 12: A method for wireless communications at a wireless device, comprising: receiving a report message comprising an indication of one or more performance parameters comprising at least one of an energy threshold for non-coherent transmission by a second wireless device, and a delay constraint for non-coherent transmission by the second wireless device; transmitting, based at least in part on the one or more performance parameters, duty cycle information for non-coherent transmissions; and receiving a message via one or more transmission occasions according to a duty cycle that is based at least in part on the duty cycle information.

Aspect 13: The method of aspect 12, wherein receiving the message comprises: receiving a first portion of the message via a first transmission occasion of the one or more transmission occasions, the first transmission occasion comprising a first set of time resources and a first set of frequency resources; and receiving a second portion of the message via a second transmission occasion of the one or more transmission occasions, the second transmission occasion comprising a second set of time resources and a second set of frequency resources, wherein the second set of time resources is offset from the first set of time resources by a time duration according to the duty cycle.

Aspect 14: The method of any of aspects 12 through 13, wherein the duty cycle information comprises a duty cycle value that corresponds to a first transmission occasion of the one or more transmission occasions occurring within the duty cycle, and a second transmission occasion of the one or more transmission occasions occurring with the duty cycle, the second transmission occasion occurring in a last available transmission occasion prior to expiration of a time duration indicated by the delay constraint.

Aspect 15: The method of aspect 14, further comprising: selecting the duty cycle value from a plurality of candidate duty cycle values based at least in part on the delay constraint, wherein the selected duty cycle value corresponds to the duty cycle having a duration that satisfies the delay constraint.

Aspect 16: The method of any of aspects 12 through 15, wherein the duty cycle information comprises an indication of a last transmission occasion of the one or more transmission occasions occurring within the duty cycle.

Aspect 17: The method of aspect 16, further comprising: transmitting control signaling indicating a plurality of candidate transmission occasions, wherein the duty cycle information comprises an indication of the last transmission occasion from the plurality of candidate transmission occasions.

Aspect 18: The method of any of aspects 16 through 17, further comprising: selecting the last transmission occasion from a plurality of candidate transmission indications based at least in part on the last transmission occasion occurring prior to expiration of the delay constraint.

Aspect 19: The method of any of aspects 12 through 18, further comprising: transmitting control signaling indicating a lookup table comprising a plurality of index values and a plurality of candidate duty cycle values, each index value of the plurality of index values corresponding to a respective candidate duty cycle value of the plurality of candidate duty cycle values, wherein the duty cycle information comprises an index value of the plurality of index values indicating a first duty cycle value corresponding to the duty cycle.

Aspect 20: The method of any of aspects 12 through 19, further comprising: transmitting control signaling indicating whether the wireless device is to transmit one or more repetitions of the message during the duty cycle, wherein receiving the message is based at least in part on receiving the control signaling.

Aspect 21: The method of aspect 20, further comprising: determining, based at least in part on the one or more performance parameters, whether the wireless device is to transmit one or more repetitions of the message during the duty cycle, wherein transmitting the control signaling is based at least in part on the determining.

Aspect 22: The method of any of aspects 12 through 21, further comprising: receiving the message via a first set of transmission occasions; and receiving a repetition of the message via a second set of transmission occasions, wherein the first set of transmission occasions and the second set of transmission occasions occur within the duty cycle according to the duty cycle information.

Aspect 23: The method of aspect 22, wherein the first set of transmission occasions and the second set of transmission occasions of the duty cycle satisfy the delay constraint.

Aspect 24: The method of any of aspects 12 through 23, wherein transmitting the message comprises transmitting one or more non-coherent peaky transmissions.

Aspect 25: A wireless device for wireless communications, comprising one or more memories storing processor-executable code, and one or more processors coupled with the one or more memories and individually or collectively operable to execute the code to cause the wireless device to perform a method of any of aspects 1 through 11.

Aspect 26: A wireless device for wireless communications, comprising at least one means for performing a method of any of aspects 1 through 11.

Aspect 27: A non-transitory computer-readable medium storing code for wireless communications, the code comprising instructions executable by one or more processors to perform a method of any of aspects 1 through 11.

Aspect 28: A wireless device for wireless communications, comprising one or more memories storing processor-executable code, and one or more processors coupled with the one or more memories and individually or collectively operable to execute the code to cause the wireless device to perform a method of any of aspects 12 through 24.

Aspect 29: A wireless device for wireless communications, comprising at least one means for performing a method of any of aspects 12 through 24.

Aspect 30: A non-transitory computer-readable medium storing code for wireless communications, the code comprising instructions executable by one or more processors to perform a method of any of aspects 12 through 24.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, or any combination thereof. Software shall be construed broadly to mean instructions, instruction sets, code, code segments, program code, programs, subprograms, software modules, applications, software applications, software packages, routines, subroutines, objects, executables, threads of execution, procedures, or functions, whether referred to as software, firmware, middleware, microcode, hardware description language, or otherwise. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, phase change memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., including a list of items prefaced by a phrase such as “at least one of” or “one or more of”) indicates an inclusive list such that, for example, a list of at least one of A, B, or C means, e.g., A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” or “identify” or “identifying” encompasses a variety of actions and, therefore, “determining” or “identifying” can include calculating, computing, processing, deriving, investigating, looking up (such as via looking up in a table, a database or another data structure), ascertaining and the like. Also, “determining” or “identifying” can include receiving (such as receiving information or signaling, e.g., receiving information or signaling for determining, receiving information or signaling for identifying), accessing (such as accessing data in a memory, or accessing information) and the like. Also, “determining” or “identifying” can include resolving, obtaining, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A wireless device, comprising:
one or more memories storing processor-executable code; and
one or more processors coupled with the one or more memories and individually or collectively operable to execute the code to cause the wireless device to:
transmit a report message comprising an indication of one or more performance parameters comprising at least one of an energy threshold for non-coherent transmission, and a delay constraint for non-coherent transmission;
receive, based at least in part on the one or more performance parameters, duty cycle information for non-coherent transmission; and
transmit a message via one or more transmission occasions according to a duty cycle that is based at least in part on the duty cycle information.

2. The wireless device of claim 1, wherein, to transmit the message, the one or more processors are individually or collectively operable to execute the code to cause the wireless device to:
transmit a first portion of the message via a first transmission occasion of the one or more transmission occasions, the first transmission occasion comprising a first set of time resources and a first set of frequency resources; and
transmit a second portion of the message via a second transmission occasion of the one or more transmission occasions, the second transmission occasion comprising a second set of time resources and a second set of frequency resources, wherein the second set of time resources is offset from the first set of time resources by a time duration according to the duty cycle.

3. The wireless device of claim 1, wherein:
the duty cycle information comprises a duty cycle value, and
a peak transmission power for transmitting the message is equal to an average transmission power divided by the duty cycle value.

4. The wireless device of claim 1, wherein the duty cycle information comprises a duty cycle value that corresponds to a first transmission occasion of the one or more transmission occasions occurring within the duty cycle, and a second transmission occasion of the one or more transmission occasions occurring with the duty cycle, the second transmission occasion occurring in a last available transmission occasion prior to expiration of the delay constraint.

5. The wireless device of claim 1, wherein the duty cycle information comprises an indication of a last transmission occasion of the one or more transmission occasions occurring within the duty cycle.

6. The wireless device of claim 5, wherein the one or more processors are individually or collectively further operable to execute the code to cause the wireless device to:
receive control signaling indicating a plurality of candidate transmission occasions, wherein the duty cycle information comprises an indication of the last transmission occasion from the plurality of candidate transmission occasions.

7. The wireless device of claim 1, wherein the one or more processors are individually or collectively further operable to execute the code to cause the wireless device to:
receive control signaling indicating a lookup table comprising a plurality of index values and a plurality of candidate duty cycle values, each index value of the plurality of index values corresponding to a respective candidate duty cycle value of the plurality of candidate duty cycle values, wherein the duty cycle information comprises an index value of the plurality of index values indicating a first duty cycle value corresponding to the duty cycle.

8. The wireless device of claim 1, wherein the one or more processors are individually or collectively further operable to execute the code to cause the wireless device to:
receive control signaling indicating whether the wireless device is to transmit one or more repetitions of the message during the duty cycle, wherein transmission of the message is based at least in part on the control signaling.

9. The wireless device of claim 1, wherein, to transmit the message, the one or more processors are individually or collectively operable to execute the code to cause the wireless device to:
transmit the message via a first set of transmission occasions; and
transmit a repetition of the message via a second set of transmission occasions, wherein the first set of transmission occasions and the second set of transmission occasions occur within the duty cycle according to the duty cycle information.

10. The wireless device of claim 9, wherein the first set of transmission occasions and the second set of transmission occasions of the duty cycle satisfy the delay constraint.

11. The wireless device of claim 1, wherein, to transmit the message, the one or more processors are individually or collectively operable to execute the code to cause the wireless device to:
transmit one or more non-coherent peaky transmissions.

12. A wireless device, comprising:
one or more memories storing processor-executable code; and
one or more processors coupled with the one or more memories and individually or collectively operable to execute the code to cause the wireless device to:
receive a report message comprising an indication of one or more performance parameters comprising at least one of an energy threshold for non-coherent transmission by a second wireless device, and a delay constraint for non-coherent transmission by the second wireless device;
transmit, based at least in part on the one or more performance parameters, duty cycle information for non-coherent transmissions; and
receive a message via one or more transmission occasions according to a duty cycle that is based at least in part on the duty cycle information.

13. The wireless device of claim 12, wherein, to receive the message, the one or more processors are individually or collectively operable to execute the code to cause the wireless device to:
receive a first portion of the message via a first transmission occasion of the one or more transmission occasions, the first transmission occasion comprising a first set of time resources and a first set of frequency resources; and
receive a second portion of the message via a second transmission occasion of the one or more transmission occasions, the second transmission occasion comprising a second set of time resources and a second set of frequency resources, wherein the second set of time resources is offset from the first set of time resources by a time duration according to the duty cycle.

14. The wireless device of claim 12, wherein the duty cycle information comprises a duty cycle value that corresponds to a first transmission occasion of the one or more transmission occasions occurring within the duty cycle, and a second transmission occasion of the one or more transmission occasions occurring with the duty cycle, the second transmission occasion occurring in a last available transmission occasion prior to expiration of a time duration indicated by the delay constraint.

15. The wireless device of claim 14, wherein the one or more processors are individually or collectively further operable to execute the code to cause the wireless device to:
select the duty cycle value from a plurality of candidate duty cycle values based at least in part on the delay constraint, wherein the selected duty cycle value corresponds to the duty cycle having a duration that satisfies the delay constraint.

16. The wireless device of claim 12, wherein the duty cycle information comprises an indication of a last transmission occasion of the one or more transmission occasions occurring within the duty cycle.

17. The wireless device of claim 16, wherein the one or more processors are individually or collectively further operable to execute the code to cause the wireless device to:
transmit control signaling indicating a plurality of candidate transmission occasions, wherein the duty cycle information comprises an indication of the last transmission occasion from the plurality of candidate transmission occasions.

18. The wireless device of claim 16, wherein the one or more processors are individually or collectively further operable to execute the code to cause the wireless device to:
select the last transmission occasion from a plurality of candidate transmission indications based at least in part on the last transmission occasion occurring prior to expiration of the delay constraint.

19. The wireless device of claim 12, wherein the one or more processors are individually or collectively further operable to execute the code to cause the wireless device to:
transmit control signaling indicating a lookup table comprising a plurality of index values and a plurality of candidate duty cycle values, each index value of the plurality of index values corresponding to a respective candidate duty cycle value of the plurality of candidate duty cycle values, wherein the duty cycle information comprises an index value of the plurality of index values indicating a first duty cycle value corresponding to the duty cycle.

20. The wireless device of claim 12, wherein the one or more processors are individually or collectively further operable to execute the code to cause the wireless device to:
transmit control signaling indicating whether the wireless device is to transmit one or more repetitions of the message during the duty cycle, wherein reception of the message is based at least in part on the control signaling.

21. The wireless device of claim 20, wherein the one or more processors are individually or collectively further operable to execute the code to cause the wireless device to:
determine, based at least in part on the one or more performance parameters, whether the wireless device is to transmit one or more repetitions of the message during the duty cycle, wherein transmission of the control signaling is based at least in part on the determining.

22. The wireless device of claim 12, wherein the one or more processors are individually or collectively further operable to execute the code to cause the wireless device to:
receive the message via a first set of transmission occasions; and
receive a repetition of the message via a second set of transmission occasions, wherein the first set of transmission occasions and the second set of transmission occasions occur within the duty cycle according to the duty cycle information.

23. The wireless device of claim 22, wherein the first set of transmission occasions and the second set of transmission occasions of the duty cycle satisfy the delay constraint.

24. The wireless device of claim 12, wherein, to receive the message, the one or more processors are individually or collectively operable to execute the code to cause the wireless device to:
receive one or more non-coherent peaky transmissions.

25. A method for wireless communications at a wireless device, comprising:
transmitting a report message comprising an indication of one or more performance parameters comprising at least one of an energy threshold for non-coherent transmission, and a delay constraint for non-coherent transmission;
receiving, based at least in part on the one or more performance parameters, duty cycle information for non-coherent transmission; and
transmitting a message via one or more transmission occasions according to a duty cycle that is based at least in part on the duty cycle information.

26. The method of claim 25, wherein transmitting the message comprises:
transmitting a first portion of the message via a first transmission occasion of the one or more transmission occasions, the first transmission occasion comprising a first set of time resources and a first set of frequency resources; and
transmitting a second portion of the message via a second transmission occasion of the one or more transmission occasions, the second transmission occasion comprising a second set of time resources and a second set of frequency resources, wherein the second set of time resources is offset from the first set of time resources by a time duration according to the duty cycle.

27. The method of claim 25, wherein the duty cycle information comprises a duty cycle value, and a peak transmission power for transmitting the message is equal to an average transmission power divided by the duty cycle value.

28. The method of claim 25, wherein the duty cycle information comprises a duty cycle value that corresponds to a first transmission occasion of the one or more transmission occasions occurring within the duty cycle, and a second transmission occasion of the one or more transmission occasions occurring with the duty cycle, the second transmission occasion occurring in a last available transmission occasion prior to expiration of the delay constraint.

29. The method of claim 25, wherein the duty cycle information comprises an indication of a last transmission occasion of the one or more transmission occasions occurring within the duty cycle.

30. A method for wireless communications at a wireless device, comprising:
receiving a report message comprising an indication of one or more performance parameters comprising at least one of an energy threshold for non-coherent transmission by a second wireless device, and a delay constraint for non-coherent transmission by the second wireless device;
transmitting, based at least in part on the one or more performance parameters, duty cycle information for non-coherent transmissions; and
receiving a message via one or more transmission occasions according to a duty cycle that is based at least in part on the duty cycle information.
